(19) United States
(12) Patent Application Publication
(10) Pub. No.: US 2003/0084098 A1
(43) Pub. Date: May 1, 2003

(54) Navigation server for use with, for example, a wireless web access device having a navigation control unit

(76) Inventors: Daniel Lavin, San Francisco, CA (US); Henriette Wendt, London (GB); Willliam Rini, Marina del Rey, CA (US)

Correspondence Address: ST. ONGE STEWARD JOHNSTON & REENS, LLC, 986 BEDFORD STREET, STAMFORD, CT, 06905-5619, US

(21) Appl. No.: 10/269,154

(22) Filed: Oct. 11, 2002

Related U.S. Application Data
(63) Continuation of application No. PCT/US01/12183, filed on Apr. 13, 2001.

(30) Foreign Application Priority Data
Apr. 13, 2000 (GB) 0009004.3

(51) Int. Cl. G06F 15/16

(52) U.S. Cl. 709/203

(57) ABSTRACT

A system for providing redirection addresses for a wireless web access device is disclosed. The wireless web access device is coupled to a navigation control unit that includes user controls, such as buttons. A navigation server coupled to the wireless web access device via a network (e.g., the Internet), receives signals identifying the navigation control unit and one of the user controls actuated by a user. In response thereto, the navigation server accesses a database to identify a redirect address, and provides such address to the wireless web access device. Also disclosed are methods, data structures, and display descriptions associated with the navigation server.

### CROSS-REFERENCE TO RELATED APPLICATION

This application claims the benefit of U.K. Patent Application No. GB 0009004.3, filed Apr. 13, 2000, currently pending.

### TECHNICAL FIELD

The present disclosure relates in general to a navigation control unit for use with a wireless resource access device.

### BACKGROUND

The Internet comprises a vast number of computers and computer networks interconnected through communication channels. The Internet is used for a variety of reasons, including electronic commerce, exchanging information such as electronic mail, retrieving information and doing research, and the like. Many standards have been established for exchanging information over the Internet, such as electronic mail, Gopher, and the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is tpically a special-purpose application program for requesting and displaying web pages.

Currently, web pages are often defined using HyperText Markup Language (“HTML”). HTML provides a standard set of tags that define how a web page is to be displayed. When a user makes a request to the browser to display a web page, the browser sends the request to the server computer system to transfer to the client computer system an HTtL document that defines the web page. When the requested HTML document is received by the client computer system, the browser displays the web page as defined by the HTML document. The HTML document contains various tags that control the display of text, graphics, controls, and other features. The HTML document may contain URLs of other web pages available on that server computer system or on other server computer systems.

New protocols exist, such as Extensible Mark-up Language (“XML”) and Wireless Access Protocol (“WAP”). XML provides greater flexibility over HTML. WAP provides, among other things, the ability to view web pages over hand-held, wireless devices, such as cell phones and portable computers (e.g., PDA's).

Recently, portable communication devices such as mobile telephones have been developed for access to information on a local or global computer network. These devices come in many different forms including, for example, a mobile telephone or a palm top computer, and will be referred to generally as a wireless web access device.

Customers of the wireless web access device desire to have devices that provide a large amount of functionality and yet are small, lightweight, and affordable. To accommodate these conflicting desires, manufacturers have made the user controls smaller and have made each user control perform potentially a variety of functions. For example, many wireless web access devices require users to press a small button up to three times in order to input just one character. Moreover, users often have to navigate through a large number of web pages or levels of web pages, requiring a large number of often-cumbersome inputs. Accordingly, it is desired to increase both the functionality and ease of use of wireless web access devices.

### BRIEF DESCRIPTION OF THE DRAWINGS

FIG. 1 is schematic view of a wireless web access device with a first preferred embodiment of a navigation control unit.

FIG. 2 is a schematic view of a second preferred embodiment of the navigation control unit.

FIG. 3 is a schematic view of a third preferred embodiment of the navigation control unit.

FIG. 4 is a schematic view of a preferred control circuit of the navigation control unit.

FIG. 5 is a flowchart showing a preferred method of operation of the navigation control unit.

FIG. 6 is a flowchart showing a preferred method for providing higher level functionality in the navigation control unit.

FIG. 7 is a block diagram of a suitable computer for employing aspects of the invention.

FIG. 8 is a block diagram illustrating a suitable system in which aspects of the invention may operate in a networked computer environment.

FIG. 9 is a block diagram illustrating an alternative system to that of FIG. 8.

FIG. 10 is a block diagram illustrating a suitable system in which aspects of the invention may operate in a networked computer environment.

FIG. 11 is a flowchart showing a preferred method for providing higher level functionality in the navigation control unit.

FIG. 12A is a data block diagram illustrating a suitable user properties lookup table.

FIG. 12B is a data block diagram illustrating a suitable partner table.

FIG. 13 is a flowchart showing a preferred method for providing higher level functionality in the navigation server.

FIG. 14 is an example of a partner setup web page for use by the system of FIG. 13.

FIG. 15 is an example of a partner verification web page for use by the system of FIG. 13.

FIG. 16 is an example of a partner administration web page for use by the system of FIG. 13.

FIG. 17 is an example of a edit navigation control unit web page for use by the system of FIG. 13.

FIG. 18 is a flowchart showing a method of providing redirection services.

FIG. 19 is a diagram illustrating problems in a supply chain solved by aspects of the invention.

FIG. 20 is a block diagram illustrating message flow with the navigation server.

In the drawings, identical reference numbers identify identical or substantially similar elements or acts. To easily identify the discussion of any particular element or act the most significant digit or digits in a reference number refer to the Figure number in which that element is first introduced (e.g., element 1104 is first introduced and discussed with respect to FIG. 11).

A portion of this disclosure contains material to which a claim for copyright is made. The copyright owner has no objection to the facsimile reproduction by anyone of the patent document or the patent disclosure (including Figures), as it appears in the Patent and Trademark Office patent file or records, but reserves all other copyright rights whatsoever.

The headings provided herein are for convenience only and do not necessarily affect the scope or meaning of the claimed invention.

### DETAILED DESCRIPTION

The following description provides specific details for a thorough understanding of, and enabling description for, embodiments of the invention. However, one skilled in the art will understand that the invention may be practiced without these details. In other instances, well known structures and functions have not been shown or described in detail to avoid unnecessarily obscuring the description of the embodiments of the invention.

Depicted embodiments of the present invention are intended for use with any suitable portable wireless web access device. By way of example, the preferred embodiments will be described with reference to a wireless web access device 110, such as a mobile telephone, Internet-enabled PDA, automobile-based web access device, or other portable or mobile computing or communication devices. In a preferred embodiment, the wireless device 110 is a cellular telephone such as a GSM device, preferably operating under the wireless application protocol (WAP) or similar communications protocol. The wireless device 110 typically has a display screen 111 and integral user controls 112 which are suitably buttons such as membrane switches.

Under a communications protocol such as WAP, the wireless device 110 is used to access a wide range of information on databases linked by a global computer network such as the Internet. The wireless device 110 uses a browser function to access the Internet 115 through a gateway portal 114. Navigation between sites and between pages of a site is performed using the integral user controls 112 to control a browser function of the wireless device 110. Often it is desired to make the wireless device 110 as small as possible and a problem arises in that the integral user controls 112 become smaller and more difficult to operate. Further, it is desired to keep the number of user controls to a minimum for space and cost, but by contrast it is also desired to increase the number of functions available on the device. As a result each integral user control 112 typically performs a number of different functions often operated by pressing the same button several times or by pressing control buttons in various different combinations. Often, a user must navigate a menu structure in order for the web access device to perform a desired function. It has been found that a menu structure having more than one or two levels is particularly difficult for users to navigate.

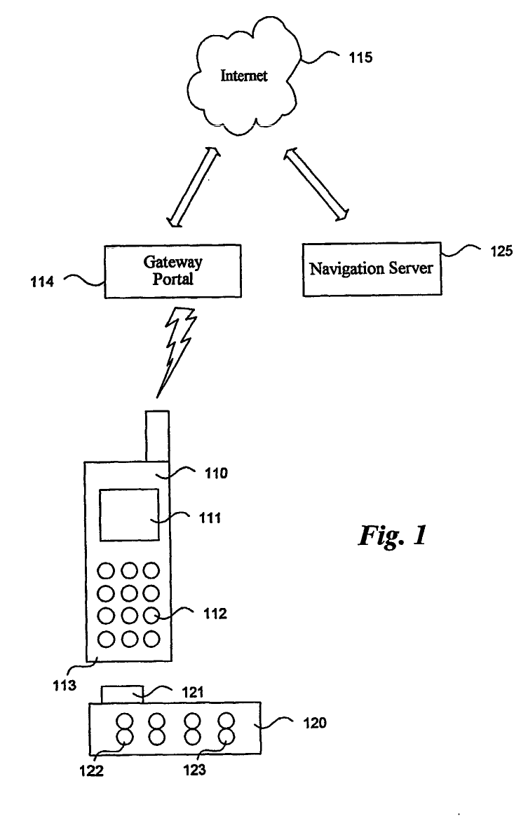

Referring to FIG. 1, in a first preferred embodiment the present invention provides a navigation control unit 120 that is coupleable to the wireless device 110. In this embodiment, the navigation control unit 120 is coupleable directly to the wireless device 110 such as by a connector 121 entering a corresponding port 113 on the wireless device 110. The connector 121 provides both electrical and mechanical coupling between the navigation control unit 120 and the web access device 110. The navigation control unit 120 is supported closely adjacent to the web access device 110. The port 113 in this example is shown at the bottom of the wireless device 110, but can be provided elsewhere on the device or remote therefrom such as on an adapter lead.

Unless described otherwise below, the construction and operation of the various blocks shown in FIG. 1 and the other Figures are of conventional design. As a result, such blocks need not be described in further detail beyond that provided herein, because they will be understood by those skilled in the relevant art. Such further detail is omitted for brevity and so as not to obscure the detailed description of the invention. Any modifications necessary to the blocks in FIG. 1 (or other Figures and embodiments) can be readily made by one skilled in the relevant art based on the detailed description provided herein.

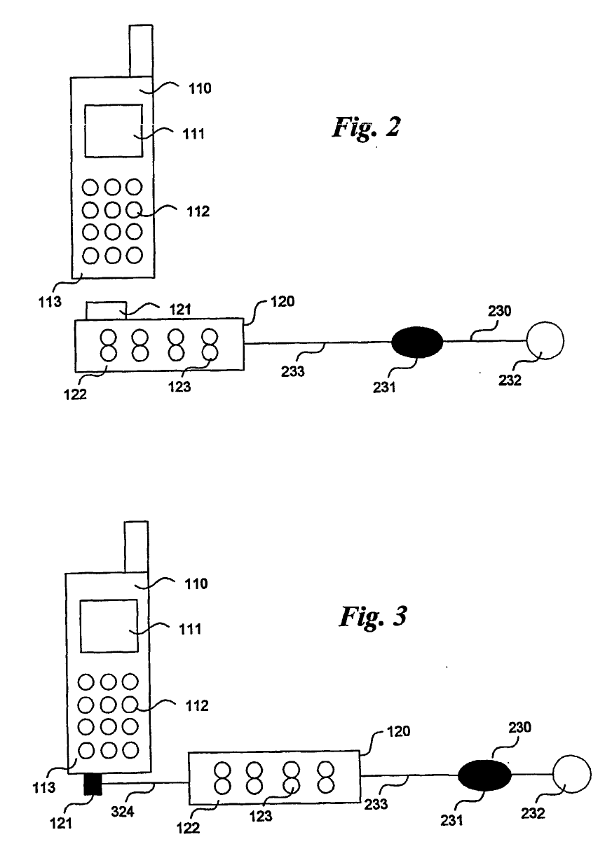

FIG. 2 shows a second preferred embodiment wherein the navigation control unit 120 comprises a handsfree unit 230 including a microphone 231 and an earpiece 232. Suitably, the handsfree unit 230 is coupled to the navigation control unit 120 by a communication link 233, such as a cord. Alternatively, a local wireless link is provided for communication between the navigation control unit 120 and the handsfree unit 230, such as by using optical, infrared or radio frequency signals.

FIG. 3 shows a third preferred embodiment where the navigation control unit 120 is provided remote from the wireless device 110 linked by a communication link 324, such as a cord or a local wireless link. Conveniently, in this embodiment the wireless device 110 may be carried about a user's person such as in a pocket, the navigation control unit 120 may be carried separately such as in the hand, on a belt or on a jacket lapel, and the handsfree unit 230 may be provided about the user's head.

In an alternative embodiment, the navigation control unit 120 may be attached to a replaceable part of wireless web access device 110, such as a battery pack. In this example, the battery pack and navigation control unit 120 could be packaged and sold together to create a potentially more desirable product. Similarly, any replaceable part related to the wireless device 110, such as antennas or removable attachments, could be packaged with a navigation control unit 120.

The navigation control unit 120 may take any suitable form factor. A generally rectangular box is shown in FIGS. 1, 2 and 3 merely for illustration. The navigation control unit 120 may take any suitable size. In the first and second embodiments, at least the part of the navigation control unit 120 in the region of the connector 121 is sized and shaped to correspond with external contours of the wireless device 110 in the region of the port 113, giving a neat visual appearance and assisting mechanical stability.

In other alternative embodiments, the navigation control unit 120 may take other form factors, such as a watch or pen. This may be particularly useful in embodiments where the navigation control unit 120 is connected to the wireless device 110 via a remote wireless link.

The navigation control unit 120 provides at least one user control 122, and preferably a plurality of user controls as illustrated. These user controls 122 on the navigation control unit 120 are remote from the integral control buttons 112 provided on the web access device 110. The user controls 122 may take any suitable form, and are preferably keys such as membrane switches. As described herein, a user control 122 may provide any kind of user input, including a request to link to a web site, a scrolling or other control command, powering on or off, data entry, etc. The user control 122 can be of any acceptable design, such as a flat plastic button that the user presses down.

Unless described otherwise herein, the blocks depicted in FIGS. 1-3 and many of the other Figures, are well known or described in detail in the above-noted and cross-referenced patent application. Indeed, much of the detailed description provided herein is explicitly disclosed in the above patent application; most or all of the additional material of aspects of the invention will be recognized by those skilled in the relevant art as being inherent in the detailed description provided in such patent application, or well known to those skilled in the relevant art. Those skilled in the relevant art can implement aspects of the invention based on FIGS. 1-3 and the detailed description provided in the patent application.

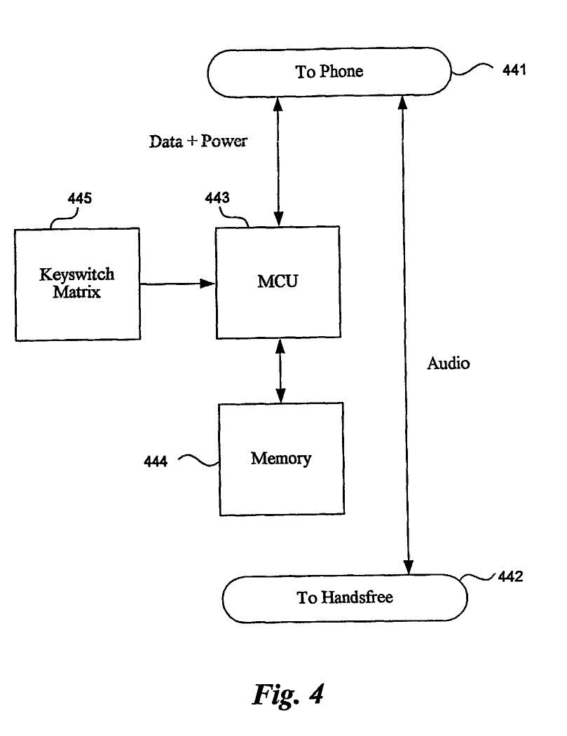

FIG. 4 shows a preferred circuit construction for the navigation control unit 120. A first i/o port 441 communicates with the wireless device 110. In one example, the i/o port 441 uses an RS232 communications interface. Communications are governed by a protocol such as GSM07.07. Power, for example at +3.3V or +5V and GND, is drawn through the port 441 from the host wireless web access device 110, or an independent power source is provided. The independent power source could be any suitable power source, including but not limited to batteries, solar-generated power, or power provided by another device, such as an automobile cigarette lighter, a wall outlet, or power source associated with a personal computer. Suitably, audio signals are passed directly from the first i/o port 441 to a second i/o port 442. The second i/o port 442 is coupled to the handsfree unit 230.

The navigation control unit 120 comprises a microprocessor 443 for executing instructions stored on an internal or external memory such as an EPROM, and coupled to internal or external temporary storage 444 such as SDRAM. The microprocessor is 443 coupled to the user controls 122 such as through a keyswitch matrix 445 in one embodiment. Further details regarding the construction of the navigation control unit may be found in U.S. patent application Ser. Nos. ______ and ______, entitled “Hardware Configuration For A Navigation Control Unit For A Wireless Computer Resource Access Device, Such As A Wireless Web Content Access Device,” and “Navigation Control Unit For A Wireless Computer Resource Access Device, Such As A Wireless Web Content Access Device,” respectively, both filed concurrently herewith.

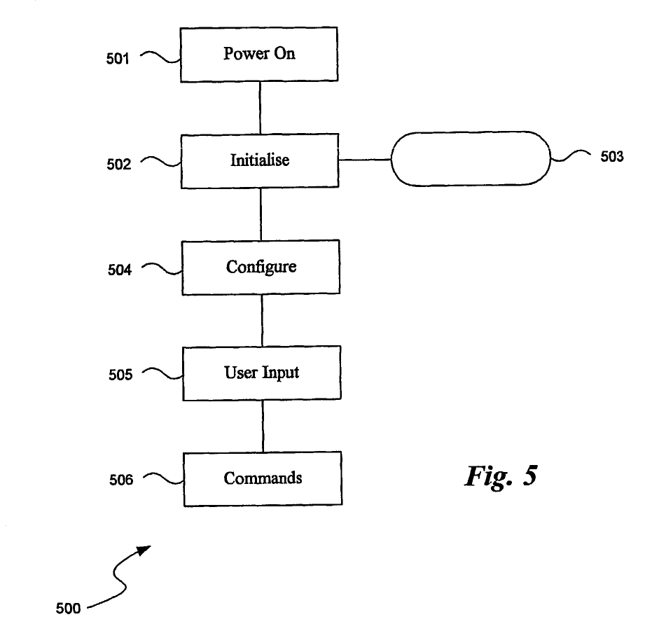

Operation of the navigation control unit 120 will now be described with reference to the flowchart of FIG. 5 as a routine 500. Each of the blocks depicted in FIG. 5 and the other flowcharts is of a sub-operation type that is either well known in the art or may be implemented by those skilled in the relevant art based on the detailed description provided herein. Each block may well include a sequence of operations that need not be described herein. Those skilled in the relevant art can create source code, microcode, or otherwise implement the invention based on the flowchart of FIG. 5 and the detailed description provided herein for operating the navigation control unit. The routine 500 is preferably stored in non-volatile memory that forms part of the microprocessor 443 or memory 444, or can be stored in removable media, such as disks, or hardwired or preprogrammed in chips, such as EEPROM semiconductor chips. Those skilled in the relevant art will appreciate that some or all of the routine 500 and other functions and methods described herein can be performed by an application specific integrated circuit (ASIC), by a digital signal processing (DSP) integrated circuit, through conventional programmed logic arrays or circuit elements.

At step 501 the navigation control unit 120 is powered on, such as by the navigation control unit 120 being connected to the wireless device 110 or by the wireless device 110 being turned on. At step 502 communications with the web access device 110 are initialized. For example, communication settings such as baud rate are negotiated. Preferably, an identify request is sent to the web access device 110 and a reply received giving identity information of the web access device 110 such as make and model information. In one embodiment, if the identity information is not received or is not recognized, operation ends at step 503.

At step 504 the navigation control unit 120 optionally sets configuration parameters of the wireless device 110 using configuration commands.

In step 505 the navigation control unit 120 waits for user input such as by polling the keyswitch matrix 445 (as described in relation to FIG. 4). The user controls 122 monitored in step 505 perform any suitable function. In response, at step 506 the navigation control unit 120 sends control commands to the wireless device 110.

Operation continues until power to the navigation control unit 120 is removed, such as when the navigation control unit 120 is disconnected from the wireless device 110 or when the wireless device 110 is turned off.

The configuration commands in step 504 are used to set a wide variety of configuration parameters of the web access device 110. The configuration parameters are determined by the nature and type of the wireless device 110. In the example of a GSM cellular device, the wireless device 110 dials a predetermined network number when attempting to establish a connection to the Internet through a predetermined gateway portal. The gateway portal is one example configuration parameter that may be set by the navigation control unit 120. Other configuration parameters may set screen displays including predetermined logos and advertising information. Still other configuration parameters of the wireless device 110 include, for example, a home page, bookmarks stored by the wireless device 110, and a ringing tone of the wireless device 110. The navigation control unit 120 conveniently sets these and other configuration parameters of the wireless device 110 for the user automatically and requiring minimal or even no user input. Advantageously, the user avoids navigation of complicated button press arrangements and menu structures in the wireless device 110. Also, where configuration parameters are sent over a live network connection, usage of network bandwidth and network time is substantially reduced by the automatic operation of the navigation control unit 120 compared with manual keypresses of the integral user controls 112 by the user.

The commands sent by the navigation control unit 120 in step 506 can be any sort of commands. In one preferred embodiment, the commands are a command sequence understandable by the wireless device 110. In one embodiment, the commands sent by the navigation control unit 120 represent a keypress sequence equivalent to a sequence of manual keypresses on the integral user controls 112. In the simplest example, each command sent to the wireless device 110 is equivalent to a single press on one of the integral user controls 112. In this embodiment, each command is a string representing a predetermined sequence of keypresses. The keypress representation is preferably determined with reference to the identity information obtained in step 502, such that the navigation control unit 120 is able to operate with a wide variety of wireless web access devices 110. In one embodiment, the keypress sequence is obtained with reference to a lookup table stored in the navigation control unit 120, such that each user control 122 maps to a plurality of stored keypress sequences and one of the keypress sequences is selected according to the identity information of the wireless device 110. The keypress sequence is then used to form the command or a sequence of commands, depending upon the communication protocol required for communication with the identified web access device 110. In another embodiment, the command includes a combination of wireless web access device commands and keypress commands. For example, the command could include a power on command, select browser commands, and then a keypress combination representing a series of single presses of the integral user control buttons 112.

The control commands sent in step 506 will now be described in more detail. A first group of user controls 122 represent most commonly used functions suitable for controlling the wireless device 110. One common functionality would be navigation functions for navigation of a local or global computer network using commands such as back, forward, stop, refresh, scroll up, scroll down and select. These first group of user controls 122 may directly replicate equivalent integral user controls 112 on the wireless device 110. It is advantageous to provide these simple user controls on the navigation control unit 120. The navigation control unit 120 has user controls 122 which are easier to use than the integral user controls 112 of the wireless device 110, for example by being larger or having improved ergonomics.

Another group of the user controls 122 provide improved functionality over the integral control buttons 112. This second group of controls perform higher level functions (described below). The navigation control unit 120 may have only the first group, or only the second group, or preferably both groups of user controls 122, or any combination of user controls 122.

Preferably, one actuation of the user controls 122 of the navigation control unit 120 represents a plurality of button presses required to perform the equivalent function using the integral user controls 112 of the wireless device 110. The controls may perform a wide variety of higher level functions, depending on the nature and type of the wireless device 110.

In one embodiment, one actuation of the user controls 122 of the navigation control unit 120 represents an e-commerce or purchase command. For example, the user control 122 could be configured as a “purchase” button and a command would be sent to the e-commerce web page requesting to purchase a product. A retailer could sell navigation control units 120 that contained a user control 122 programmed to purchase, say, the book-of-the-month and proceed to complete the e-commerce transaction based on payment and delivery information stored on a server. In an alternative embodiment, an electronic cash chip or e-wallet coupled with the navigation control unit 120 could be used to provide payment. In another alternative embodiment, a user control 122 could provide identification or authentication information about the user of the navigation control unit 120.

In one example, a selected one or more of the user controls 122 have a pre-defined hot key, or predefined link, function (depicted as hot key user controls 123). These user controls 122 each command the wireless device 110 to open a connection to a particular web site. Each of these user controls 122 links to a predetermined site, such that the user may easily access a selected few predetermined sites very conveniently. Advantageously, the user obtains access to these predetermined web sites without having to use or even understand other navigation controls on the wireless device 110 or on the control unit 120.

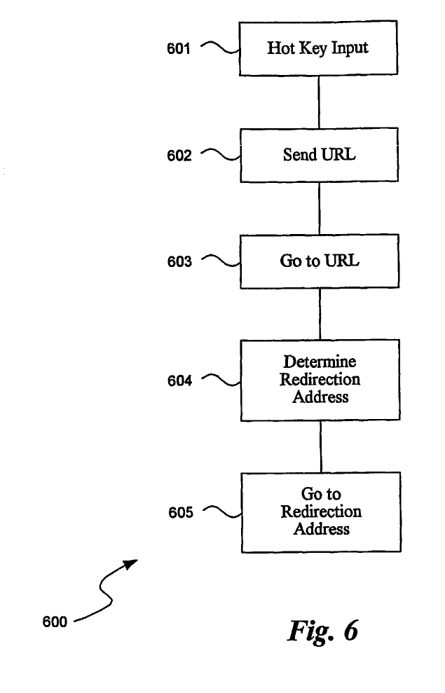

FIG. 6 shows a preferred method for performing higher level controls such as the hot key function 123 of a user control 122.

At step 601 a user control 122 is activated or actuated by the user.

At step 602 the navigation control unit 120 sends control commands to the wireless device 110. These control commands may depend upon the current state of the wireless device 110, such as establishing a web connection or opening a browser function if required. The control commands include sending a URL. Conveniently, the URL is sent as a keypress sequence, or command sequence.

In one example, the URL comprises three fields. A first field gives a web address, preferably in a standard format such as “http://www.serveraddress.xxx”. A second field provides an identifier unique to the navigation control unit 120, or unique to a predetermined group of navigation control units, such as an alphanumeric sequence of 6, 8 or 10 characters allocated to the navigation control unit 120 during manufacture. In this example the unique identifier is “XXX12345”. The third field identifies the user control 122 activated by the user as determined in step 601. In this example the user activated key number “3”. The complete URL is sent, for example, as the character sequence “http://www.serveraddress.xxx/12345/3”.

The URL may require a complicated keypress sequence. A wireless web access device 110 may have integral user controls 112 in a 4×3 number keypad layout, where each number key is used to obtain an extended alphanumeric character set by repeated keypresses. For example, the “1” button is pressed twice to give the letter “A”, or pressed three times to give the letter “B”. Hence, entering the URL manually requires many keypresses on the integral user controls 112. In the above example, the URL contains 39 characters, each of which may require several button presses by the user on the integral user controls 112, typically at least a total of 60 presses. By contrast, the user need only perform one keypress on the pre-defined user control 122 of the navigation control unit 120 to achieve the same result, giving a significant advantage.

In step 603 the wireless device 110 responds to the URL and attempts to access the web address identified by the URL, using browser functions within the wireless device 110. The first field preferably identifies a predetermined navigation server 125, which receives the URL request from the wireless device 110.

In step 604 the navigation server 125 uses the second and third fields of the URL to determine a redirection address, and returns the redirection address to the wireless device 110. The redirection address is a second URL. At step 605 the wireless device 110 is redirected to the redirection address supplied from the navigation server 125.

The redirection address is conveniently determined with reference to a lookup table stored on the navigation server 125. In this example, the second and third fields provide the information “XXX12345/3” and the redirection address is returned as a web site corresponding to user controls 122 number “3” on navigation control unit 120 number “XXX12345”. The web site may be visibly labeled on the user control 122 or adjacent thereto for the user. For example, the user control 122 number “3” is labeled “weather” and the redirection address corresponds to a web site giving weather information.

The redirection action takes place at the navigation server 125, such that the navigation control unit 120 is relatively dumb. Also, if the location of the desired web site changes or if it is desired to substitute another web site, then reprogramming is performed centrally at the navigation server 125.

In one embodiment, the navigation control unit 120 stores user specific information, and such information is delivered to the wireless device 110, for example, when accessing a particular predetermined web site from one of the user controls 122. Additionally or alternatively, such user information is supplied from the navigation control unit 120 in response to an interrogation signal issued from the wireless device 110.

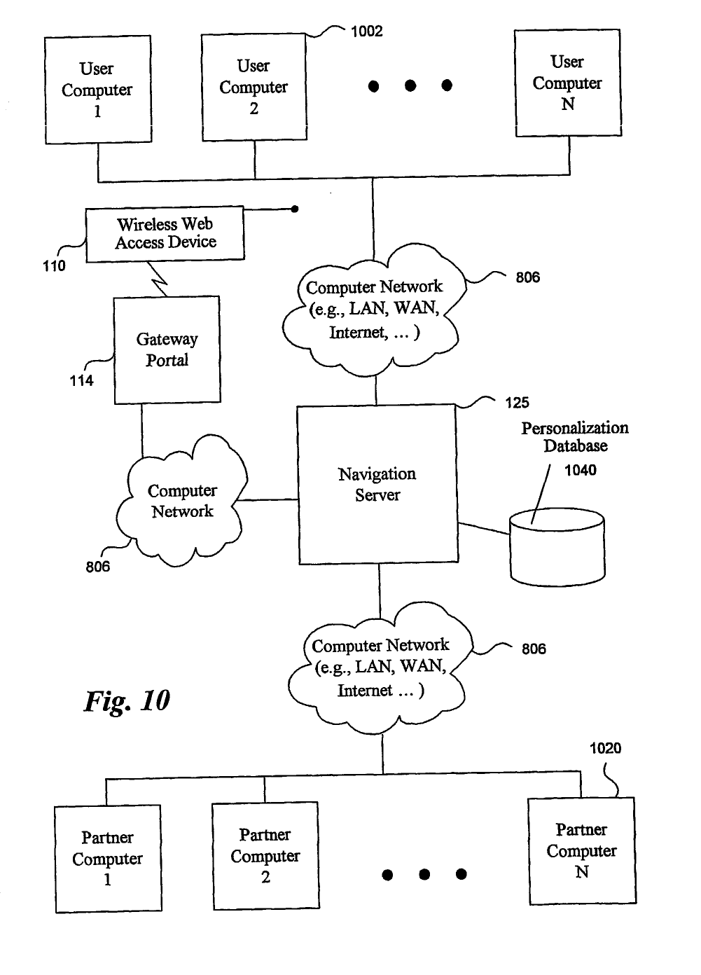

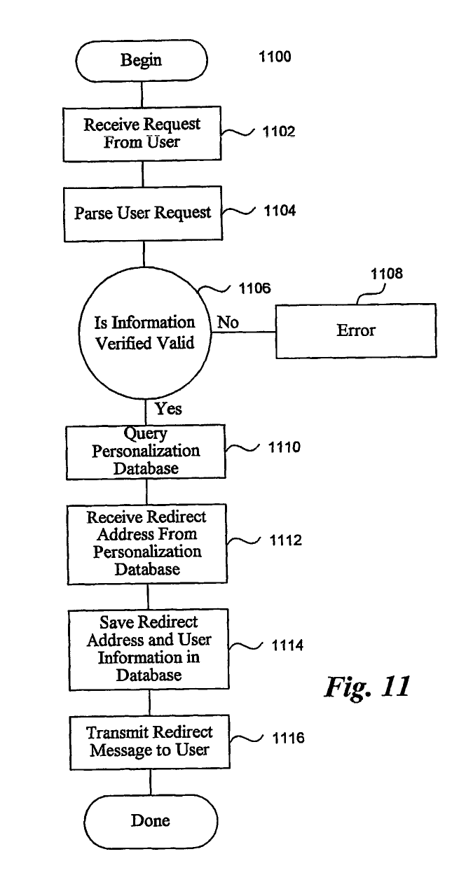

In a typical wireless web access device 110, navigation generally takes place using software controls within the device using the integral user controls 112. However, in the preferred embodiment of the present invention the navigation control unit 120 provides an external hardware controller to determine navigation of the wireless device 110. The navigation control unit 120 readily links to predetermined web sites that are of interest to the user. The user controls 122 may be tailored to the needs of each user, such as providing financial, travel, sports or any other information, by changing the central lookup table or personalization table 1040 (described in reference to FIG. 10) at the navigation server 125. The unique identifier allows each navigation control unit to have a different response, based on the redirection addresses stored at the navigation server. Further information regarding operation of the navigation control unit may be found in U.S. patent application Ser. No. _______, entitled “Software For A Navigation Control Unit For Use With A Wireless Computer Resource Access Device And Associated System,” filed concurrently herewith.

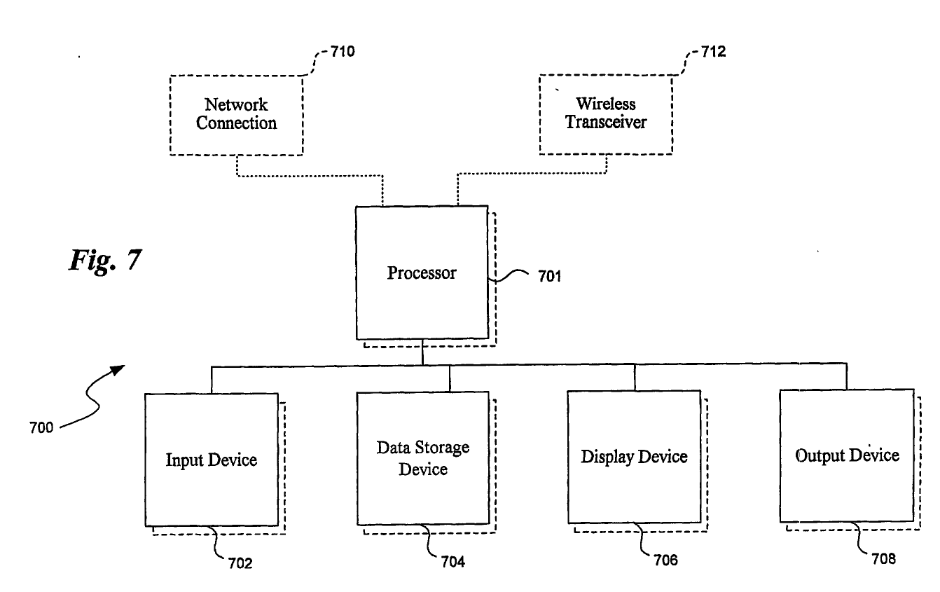

While aspects of the invention are generally described herein for use with a wireless web access device, such as a cell phone, aspects of the invention may be employed with other computer system configurations. Thus, FIG. 7 and the following discussion provide a brief, general description of a suitable computing environment in which aspects of the invention can be implemented. Although not required, aspects and embodiments of the invention will be described in the general context of computer-executable instructions, such as routines executed by a general purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 7, one embodiment of the invention employs a computer 700, such as a personal computer or workstation, having one or more processors 701 coupled to one or more user input devices 702 and data storage devices 104. The computer is also coupled to at least one output device such as a display device 706 and one or more optional additional output devices 708 (e.g. printer, plotter, speakers, tactile or olfactory output devices, etc.). The computer may be coupled to external computers, such as via an optional network connection 710, a wireless transceiver 712, or both.

The input devices 702 may include a keyboard and/or a pointing device such as a mouse. Other input devices are possible such as a microphone, joystick, pen, game pad, scanner, digital camera, video camera, and the like. The data storage devices 704 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet.

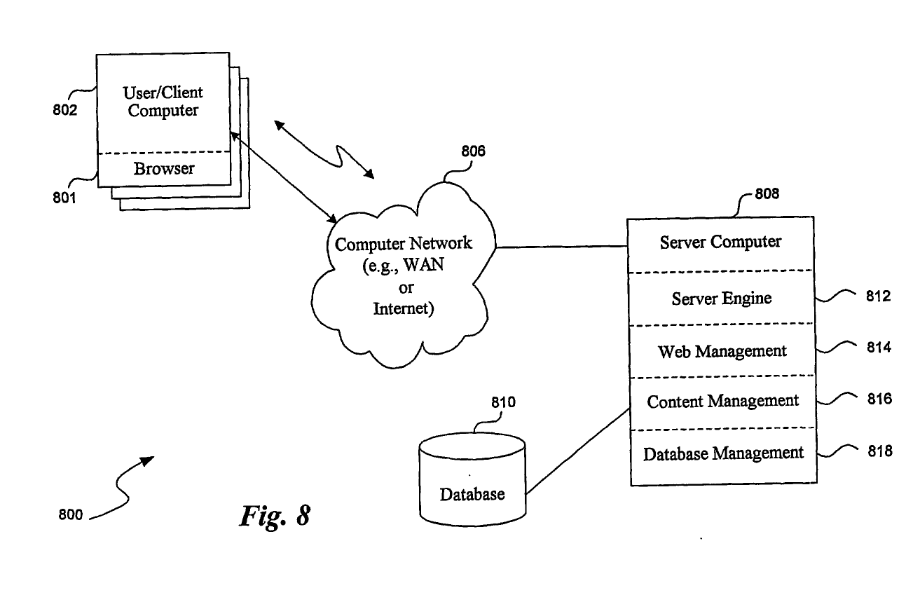

Aspects of the invention may be practiced in a variety of other computing environments. For example, referring to FIG. 8, a distributed computing environment with a web interface includes one or more user computers 802 in a system 800 are shown, each of which includes a browser program module 801 that permits the computer to access and exchange data with the Internet 806, including web sites within the World Wide Web portion of the Internet. The user computers may include one or more central processing units or other logic-processing circuitry, memory, input devices (e.g., keyboards and pointing devices), output devices (e.g., display devices and printers), and storage devices (e.g., magnetic, fixed and floppy disk drives, and optical disk drives), such as described above with respect to FIG. 7. User computers may include other program modules such as an operating system, one or more application programs (e.g., animation or graphics applications, word processing or spread sheet applications), and the like. The user computers 102 include wireless computers, such as mobile phones, personal digital assistants PDA's), palm-top computers, etc., which communicate with the Internet via a wireless link.

At least one server computer 808, coupled to the Internet or World Wide Web 806, performs much or all of the functions for receiving, routing and storing of electronic messages, such as web pages, audio signals and electronic images, such as vocal audio and animation images. While the Internet is shown, a private network, such as an intranet may likewise be used herein, A database 810, coupled to the server computer, stores much of the web pages and content exchanged between the user computers. The server computer, including the database, may employ security measures to inhibit malicious attacks on the system, and to preserve integrty of the messages and data stored therein (e.g., firewall systems, secure socket layers (SSL) password protection schemes, encryption, and the like).

The server computer 808 includes a server engine 812, a web page management component 814, a content management component 816 and a database management component 818. The server engine performs basic processing and operating system level tasks. The web page management component handles creation and display or routing of web pages. Users may access the server computer by means of a URL associated therewith. The content management component handles most of the functions in the embodiments described herein. The database management component includes storage and retrieval tasks with respect to the database, queries to the database, and storage of data such as animation graphics and audio signals.

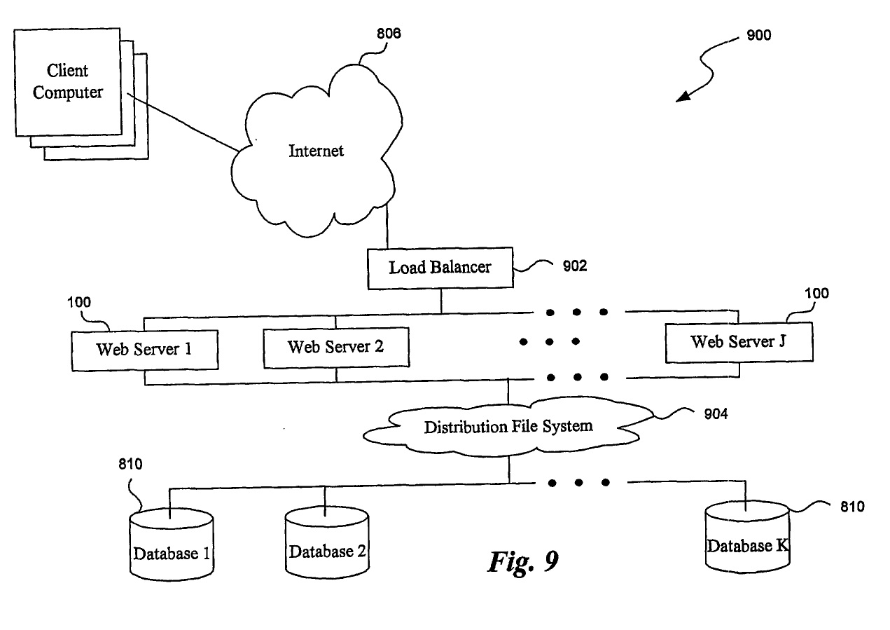

Referring to FIG. 9, an alternative embodiment to the system 800 is shown as a system 900. The system 900 is substantially similar to the system 800, but includes more than one web server computer (shown as server computers 1, 2, . . . J). A web load balancing system 902 such as Cisco's Local Director or F5's Big IP balances load on the several web server computers. Load balancing is a technique well-known in the art for distributing the processing load between two or more computers, to thereby more efficiently process instructions and route data. Such a load balancer can distribute message traffic, particularly during peak traffic times.

A distributed file system 904 couples the web servers to several databases 810 (shown as databases 1, 2 . . . K). A distributed file system is a type of file system in which the file system itself manages and transparently locates pieces of information (e.g. content pages) from remote files or databases and distributed files across the network, such as a LAN. The distributed file system also manages read and write functions to the databases. Alternative or additionally, the system may employ one or more additional load balancers (not shown) coupled between the web servers and the databases, where the databases are database clusters or Redundant Array of Inexpensive Disks (“RAID”) RAID-5 clusters communicating over fiber channel or other communication link (all as a system area network (“SAN”)).

FIG. 10 depicts a schematic view of a preferred embodiment of the navigation server 125. The navigation server 125 can be a computer 700 configured as a server 808 or the navigation server 125 can be a distributed computing system 800 (as described more fully in connection with FIGS. 8-9). The navigation server 125 is preferably a robust, fault-tolerant system with input/output capabilities and access to storage, such as in a database 810. Alternatively, multiple servers can be used in place of the navigation server 125, as described in the web load balancing system 902 and the multiple server system 900 discussed in relation to FIG. 9. The navigation server 125 is preferably connected with a personalization database 1040 used for storage of data associated with users of the navigation server 125. The personalization database 1040 is configured using MySQL in one embodiment.

The navigation server 125 is preferably connected to one or more user computers 1002 via a computer network 806, such as a WAN, LAN, or the Internet. Each user computer 1002 can be substantially similar to the computer 700 as described in relation to FIG. 7. In one embodiment, the navigation server 125 uses the Apache web server with Linux as the operating system. The user computers 1002, like the computer 700, may be any type of computer. The user computers 1002 may be used in one embodiment to allow the users of navigation control units 120 to modify some or all of the settings of their navigation control units 120. The user computers 1002 are optional and are not required for operation of the navigation server 125.

The navigation server 125 is also preferably connected to one or more partner computers 1020 via a computer network 806, such as a WAN, LAN, or the Internet. Each partner computer 1020 can be substantially similar to the computer 700 as described in relation to FIG. 7. The partner computers 1020, like the computer 700, may be any type of computer. The partner computers 1020 may be used to modify the configurations of one or more navigation control units 120. In one embodiment, a partner computer 1020 represents a computer used by a retailer that sells or distributes multiple navigation control units 120 that are similarly configured. In another embodiment, no partner computers 1020 are necessary and partners host a navigation server 125 themselves. In yet another embodiment, no partner computers 1020 are necessary.

The navigation server 125 is preferably protected with a firewall. In one embodiment, this could be a server-based firewall or a router-based firewall such as Cisco Inc.'s IOS firewall. Other firewalls include Cisco PIX or Checkpoint. Furthermore, before deploying any navigation servers, Bastille for Linux may be run on the Linux based navigation servers to improve security, such as by closing off ports and services that are not essential to the operation of the server. Other methods are providing security for the navigation server are known to those skills in the relevant art.

The redirection in the navigation server 125 is preferably implemented as an Apache handler, but alternatively could be implemented with CGI. Enterprise-level hardware and software is also preferred for the navigation server 125. information regarding constructing or reconfiguring the depicted system may be found at http://www.cpan.org. Further information may be found herein, and in Appendix A.

As described in relation to FIG. 1, in one embodiment the navigation server 125 is connected with one or more gateway portals 114 via a computer network 806, such as a WAN, LAN, or the Internet. The gateway portal 114 communicates with one or more wireless web access devices 110, preferably through a wireless communications protocol such as WAP. The navigation server may be located in proximity to Web content providers, such as the partner computers 1020. Indeed, two or more navigation server is maybe employed within the overall system a

One preferred embodiment for operation of the navigation server 125 with the user on a wireless web access device 110 equipped with a navigation control unit 120 will now be described with reference to the flowchart of FIG. 11 as a routine 1100. Each of the blocks depicted in FIG. 11 and the other flowcharts is of a sub-operation type that is either well-known in the art or may be implemented by those skilled in the relevant art based on the detailed description provided herein. Each block may well include a sequence of operations that need not be described herein. One skilled in the art will recognize that the order of blocks in FIG. 11 and other figures of the application can be modified as long as the resulting order in not inconsistent with the basic functionality.

At step 1102 the navigation server 125 receives a request from a user operating a navigation control unit 120 on a wireless web access device 110. In one embodiment, the user request includes information about the navigation control unit 120 being used, such as information identifying the user or a serial number or similar piece of data identifying the exact navigation control unit 120 being used or the class of navigation control unit being used. The class of navigation control unit 120 being used can be related to the manufacturer or partner associated with the navigation control unit 120 (e.g., the partner who programmed or distributed the unit). In this embodiment, the user request also includes information about the user control 122 actuated by the user and, if relevant, the value of the input on the user control 122 by the user (e.g., the button that was pushed, direction and force of moving a joystick, direction and extent of rotation of a rotary pad, etc.). The user request can be in any form and can include any combination of information, including one or more of the information identifying the user, user control 122 information, times, authentication information, e-commerce orders, payment information, user information, or any other types of data.

Under step 1102, the navigation server may authenticate the user beyond simply analyzing information identifying the user or the serial number of the wireless device. For example, the wireless device may perform a simple cryptographic or hash function on the serial number or other identifying information. The wireless device would then provide the results of this function in an additional field that is transmitted to the navigation server for authentication. The wireless device may store in secret number that is multiplied with the serial number to provide a result (e.g., x3d8j2x), which may then be further encrypted, and then sent to the navigation server, such as in the following form:

http://www.serveraddress.com/marie/xxx12345/3/x3d8j2x

(The path “marie” corresponds to a Mobile Address Redirect Identification Embodiment, which is simply a name for the authentication and redirection routine performed by the navigation server, as described herein.) Upon receiving the encrypted result, the navigation server simply retrieves the serial number and secret number stored in the database, multiplies (and encrypts) the result, and determines if it equals the result received. It the two are equal then the user is authenticated.

At step 1104 the user request is parsed to extract out certain relevant information. In one preferred embodiment, the user request takes the general form of the URL described in relation to step 602 of FIG. 6. Under an alternative embodiment, this step is optional and is not required if the user request is received by the navigation server 125 in a format that does not require parsing.

At step 1106 the user request, whether parsed in step 1104 or not, is validated to confirm that the information is in the right format. In one embodiment, each value extracted during the parsing process is validated in order to ensure that the information is in the right format and has not been corrupted or incorrectly entered. If the information is validated in step 1104, the process can continue. If there is an error detected in step 1104, many options for an error procedure 1108 are available, including but not limited to rejecting the request, attempting to correct the error, ignoring the error and notifying the user. Routines to perform step 1106 are wellknown to one skilled in the art.

In step 1110, the navigation server 125 queries the personalization database 1040 in order to ascertain a redirection address based on the user request. In one embodiment, the query includes information identifying the navigation control unit 120 and information about which user control 122 was actuated. The information identifying the navigation control unit 120 can be a serial number, partner identification, or any other type of data. In another embodiment, no identifying information is available and only the user control 122 actuation information is used to search the personalization database 1040.

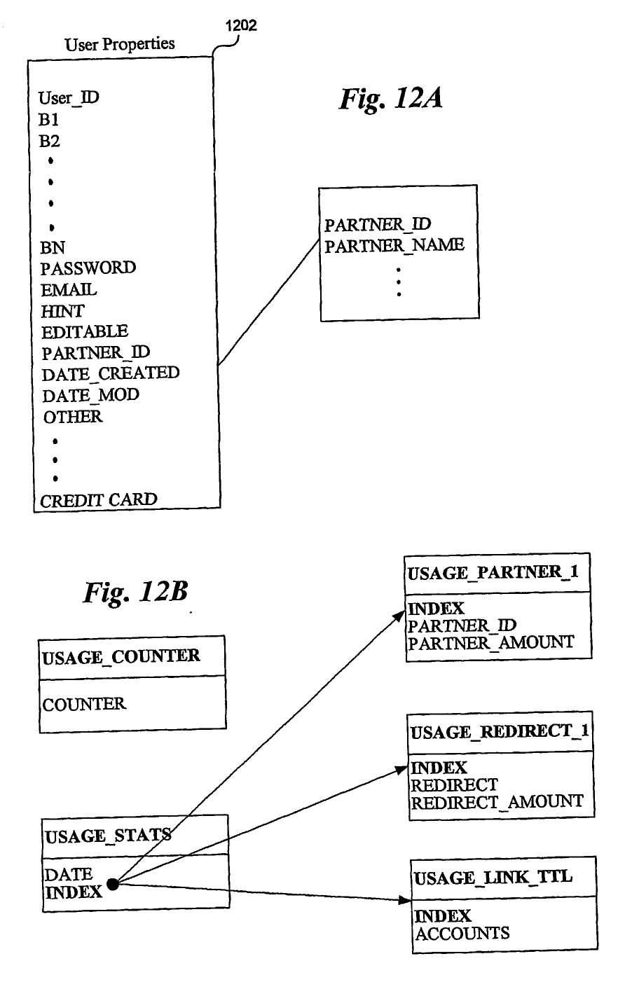

In a preferred embodiment, the personalization database 1040 is searched based on both the navigation control unit 120 identifying information and the information about the user control 122 that was actuated. The personalization database preferably contains a redirection URL associated with each user control 122 for each navigation control unit 120 (described more fully in connection with the user properties table of FIG. 12). Therefore, when information about both the navigation control unit 120 and the user control 122 are available, a redirect URL is associated with that information in a lookup table in the personalization database 1040. In some preferred embodiments, the user of the navigation control unit 120, the partner associated with the navigation control unit 120, or the operator of the navigation server 125 can change the values in the personalization database 1040, including the redirect URL associated with a user control 122 on a particular navigation control unit 120.

In step 1112 the navigation server 125 receives the redirect address from the personalization database 1040 in response to its query. In step 1114, the navigation server saves information regarding the user request, time, and redirect address in a text based log file or a database, which could be the personalization database 1040 or any other database. Information saved in this fashion can be used to collect usage information about users on navigation control units 120 for marketing, e-commerce, advertising, trouble-shooting, system optimization, report generation or other purposes.

In step 1116 a redirect message is transmitted to the wireless device 110 associated with the navigation control unit 120. In one embodiment, the redirect message is transmitted through a computer network 806 and gateway portal 114 and then transmitted to the wireless device 110. The redirect message can contain only the redirect URL or it can contain a redirect message designed for the particular wireless web access device and its protocols.

FIG. 12 depicts a preferred embodiment of the user properties lookup table 1202, which can be stored in the personalization database 1040 or any database accessible by the navigation server 120. The user properties lookup table 1202 contains one or more data entries providing information related to a particular user or navigation control unit 120. First, the user properties lookup table preferably contains a user identification (depicted as USER_ID in FIG. 12), which can be a serial number of the navigation control unit 120, an identification of a partner, an identification of the user, or any identifying information. The table also preferably contains one or more entries associated with user controls 122 (depicted as B1 to BN in FIG. 12). In one embodiment, these entries will have a redirection URL associated with each user control 122 that has been or can be configured.

The user properties lookup table 1202 can also contain data used for authentication of a user desiring to change his or her settings, embodied in FIG. 12 by PASSWORD, EMAIL, and HINT. One skilled in the art would recognize that there are a wide variety of authentication measures that are feasible, including password protection and password delivery to a confirmed e-mail address. One skilled in the art would also recognize that there are feasible mechanisms designed to help a user remember his or her password. The EDITABLE entry contains information about what entries can be changed by an authenticated user. In one embodiment, the EDITABLE entry contains a string of binary numbers to indicate which user control fields are editable by the user. For example, if there were six user control entries, and only the first three were configurable by the user, the EDITABLE entry would be “111000” (in other words, B1-B3 would be configurable, and B4-B6 would not).

In one preferred embodiment, each USER_ID entry in the user properties lookup table 1202 is associated with one or more PARTNER_ID entries. Each PARTNER_ID entry indicates the identification number of one or more portals or other partners that the navigation control unit 125 was branded for, was sold by, or is associated with. Multiple PARTNER_ID's are possible as a navigation control unit 125 could be associated with, for example, an Internet portal and a music store, each one having different capacities to modify the user properties lookup table 1202. The partner table associated with the PARTNER_ID entry has a partner name linked to each PARTNER_ID.

The user properties lookup table 1202 may also have a DATE_CREATED entry, which stores a date value indicating the date the table was created, and a DATE_MODIFIED entry, which stores a date value indicating the date that the table was last modified.

The user properties lookup table 1202 should not be limited to the above entries, as vitully any type of data about the user, partner, or navigation control unit 125 can be stored in the table. This includes statistical information about usage, such as the number of times a user actuates a user control 122, where the user is redirected to, the time and user location for each actuation, etc. Furthermore, the user properties lookup table may include credit card information for the user to facilitate automatic purchases and general electronic commerce transactions.

Referring to FIG. 12B, an example of a partner table for storing information about a portal or other partner sites for which a navigation control unit has been “branded”. The partner table includes a USAGE_COUNTER to store a counter. Each time a program or routine needs a unique number, it will query the USAGE_COUNTER to obtain a value. A USAGE_STAT table includes a date field and an index to a particular partner. Each partner, or only the top 10 partners, may be identified in one linked table (e.g., USAGE_PARTNER_{—}1 for the first partner), where the partner may be identified by an ID number, and includes an associated number of accounts associated with this partner ID, as shown. A related linked table associated with this partner (USAGE_REDIRECT_{—}1) identifies redirect addresses and amount of network traffic activity to such address. Another related linked table stores accounting or administrative data associated with the partner and/or redirect links (USAGE LINK_TTL), such as a total number of accounts at the time the record was created.

The navigation server may employ a log file to initially capture and count the number of redirect requests or accesses by navigation control units owned information: total number of user accounts (typically represented by a total number of navigation control units in use), top 10 partners as defined by number of accounts associated with that partner along with percentage of total accounts that that partner represents and top 10 URLs contained in the database and what percentage of total accounts they represent. The navigation server stores all of such tracked activity in the database for later report generation or distribution to partners, such as for a fee.

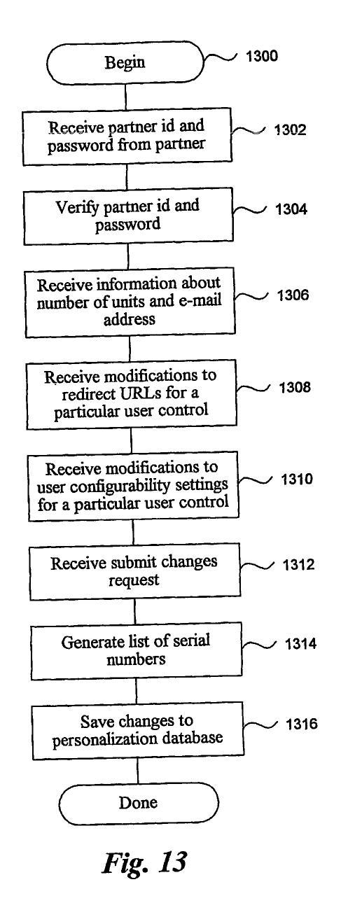

A partner administration program, operation of which is depicted in FIG. 13 as a flowchart; is used to create and maintain a list of partners that are associated with navigation control units 120 and to allow the partners to modify user personalization information for users of the navigation control units 120. One embodiment for operation of partner administration program 1300 is to locate and modify data on the navigation server 125. The operation of the partner administration program 1300 with a partner desiring a list of serial numbers for navigation control units 120 will now be described with reference to the flowchart of FIG. 13 as a routine 1300. At step 1302 the partner administration program 1300 receives a request from a partner computer 1020. In one embodiment, the partner request includes a partner identification, such as a number or name, and a password. In alternative embodiments, the partner could select a partner name from a list of partners or a password need not be required. At step 1304 the partner administration program 1300 optionally verifies that the partner identification is in the correct format. In an alternative embodiment, the partner administration program 1300 verifies that the correct password was entered by the partner.

In step 1306 the partner administration program 1300 receives information about the number of navigation control units 120 that the partner desires to have serial numbers for and an e-mail address for the partner. For example, a partner that was going to market 1000 navigation control units 120 would input “1000” as the desired number of serial numbers.

In step 1308 the partner administration program 1300 receives modifications to the redirection UTRLs for one or more user controls 122. The partner can select to modify, change or replace the redirection URL for any of the user controls in a preferred embodiment. For example, the partner could replace the URL for button 1 (a user control 122) with the URL for its own home web page. Any, all or none of the redirection URLs can be changes by the partner for any range of navigation control units 120 (from 1 up).

In step 1310 the partner administration program 1300 receives modifications to the user configurability settings. In one embodiment, the partner administration program 1300 receives an “editable” or “not editable” flag for each user control 122 to indicate whether each user control 122 can be modified by a user. This allows some user controls 122 to be “hardwired” by a partner or manufacturer while allowing users to change other user controls 122. In another embodiment, the partner makes no changes or cannot make changes to the settings, and step 1310 is not needed.

In step 1312 the partner administration program 1300 optionally receives a submit changes request from the partner. In one embodiment, the partner makes inputs or changes in steps 1306, 1308, and 1310 and then submits a submit changes request, which will submit all of the inputs or changes to the partner administration program 1300 simultaneously.

In step 1314 a list of unique navigation control unit 120 serial numbers are generated based on the first available serial number and the number of serial numbers requested by a partner. The list of serial numbers is created in a comma delimited list and e-mailed to the partner at the submitted e-mail address in a preferred embodiment. In another embodiment, the serial numbers are not sequential and a more sophisticated routine is required than a simple sequential list. In other embodiments, the serial numbers are saved to a file, printed out, or provided to the partner in any other suitable fashion.

In step 1316 the partner administration program 1300 preferably saves any changes and/or assignments of navigation control unit 120 serial numbers to a database, such as the personalization database 1040. One skilled in the art would recognize that there are many possible methods of accomplishing this task.

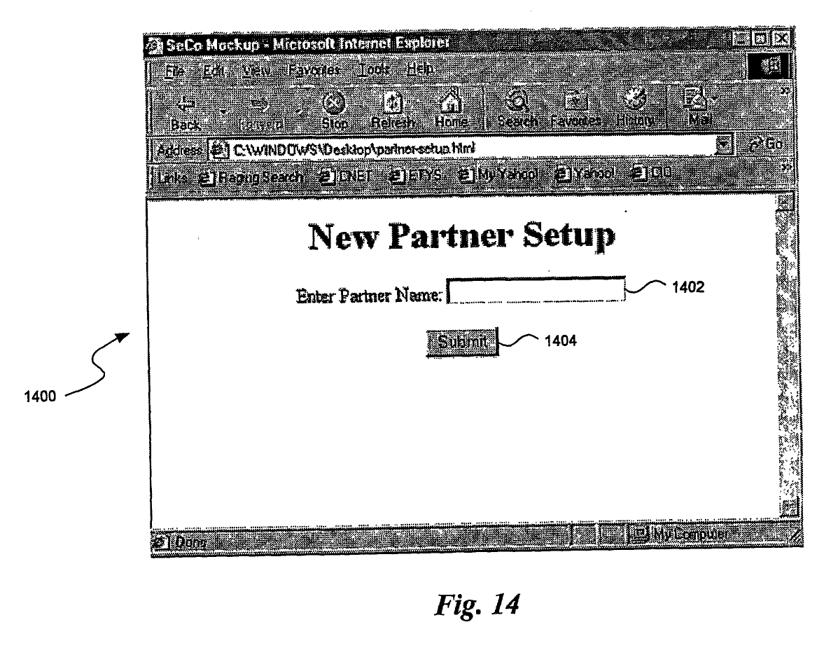

Referring to FIGS. 14-17, suitable web pages are shown for interfacing with the partner administration program 1300 by partners, administrators of the program, and users. The web pages may be implemented in XML (Extensible Markup Language) or HTML (HyperText Markup Language) scripts that provide information to a user. The web pages provide facilities to receive input data, such as in the form of fields of a form to be filled in, pull-down menus or entries allowing one or more of several entries to be selected, buttons, sliders, or other known user interface tools for receiving user input in a web page. Of course, while one or more ways of displaying information to users in pages are shown and described herein, those skilled in the relevant art will recognize that various other alternatives may be employed. The terms “screen,” “web page” and “page” are generally used interchangeably herein. While XML and HTML are described, various other methods of creating displayable data may be employed, such as the Wireless Access Protocol (“WAP”) or Handheld Device Markup Language (“HDML”).

The web pages are stored as display descriptions, graphical user interfaces, or other methods of depicting information on a computer screen (e.g., commands, links, fonts, colors, layout, sizes and relative positions, and the like), where the layout and information or content to be displayed on the page is stored in a database. In general a “link” refers to any resource locator (e.g. a URL, email address or phone number) identifying a resource on a network, such as a display description provided by an organization having a site or node on the network. A “display description,” as generally used herein, refers to any method of automatically displaying information on a computer screen in any of the above-noted formats, as well as other formats, such as email or character/code-based formats, algorithm-based formats (e.g., vector generated), or matrix or bit-mapped formats. While aspects of the invention are described herein using a networked environment, some or all features may be implemented within a single-computer environment.

Referring to FIG. 14, a suitable display description to implement the process of the partner administration program 1300 as described in reference to FIG. 13, implemented as a web page created under HTML, is shown. The partner setup web page 1400 includes a partner name field 1402 and a submit button 1404, both located in a center column. The partner name field 1402 is preferably used to enter the name of a partner that the system administrator desires to enter a partner account for. The submit button 1404 is also depicted to allow a partner or administrator to submit all of the entries on the partner setup page 1400 simultaneously.

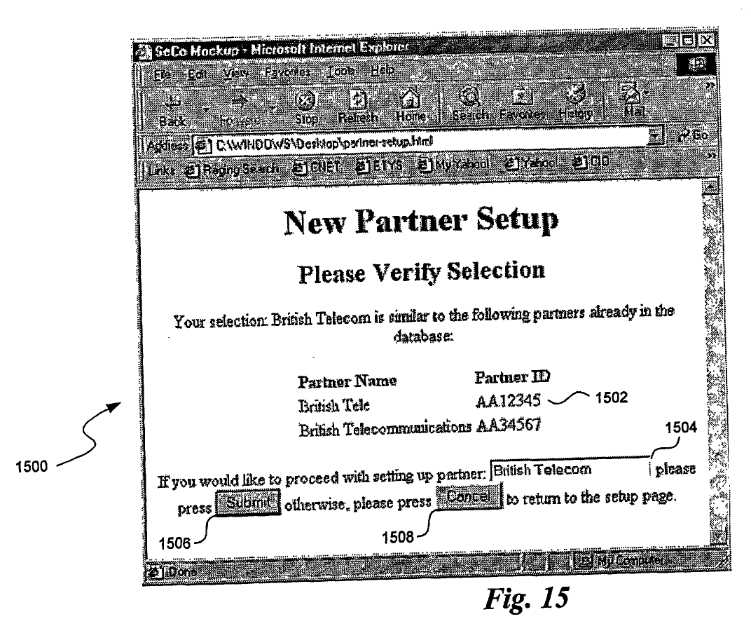

Referring to FIG. 15, a suitable display description to implement the process of the partner administration program 1300 as described in reference to FIG. 13, implemented as a web page created under HTML, is shown. The partner verification web page 1500 includes a similar partners list 1502 in a central column. The similar partners list 1502 is used to describe partner names that are similar to the partner name proposed in reference to the partner name field 1402 in FIG. 14. The proposed partner field 1504 preferably shows the partner name proposed by the administrator in relation to FIG. 14, which may be edited in the field box. The submit button 1506 is depicted to allow the administrator to proceed with the proposed partner name in spite of any similarities with pre-existing names. The cancel button 1506 is depicted to allow the administrator to cancel the process of selecting the particular proposed partner name and to return to the screen described in relation to FIG. 14.

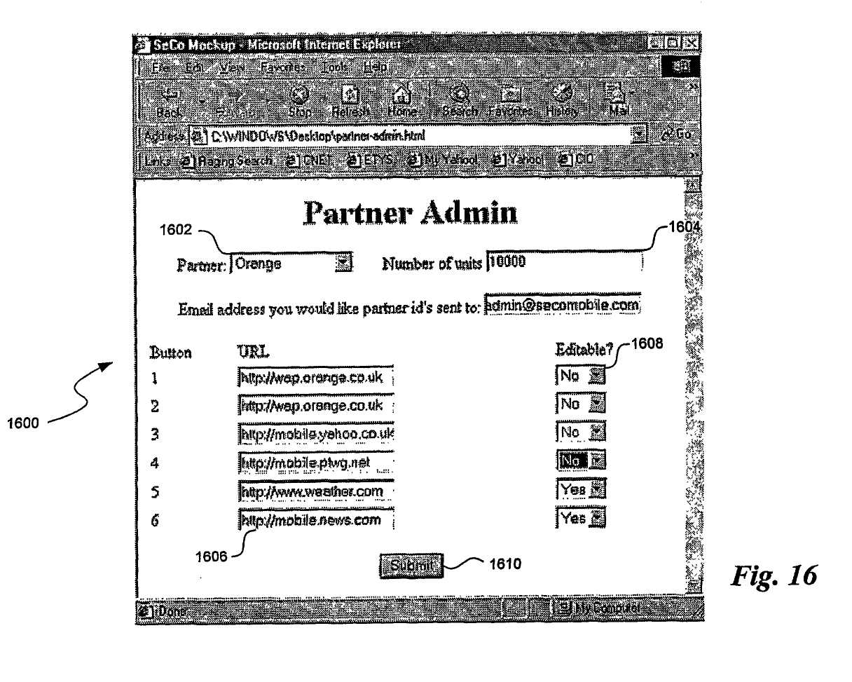

Referring to FIG. 16, a suitable display description to implement the process of the partner administration program 1300 as described in reference to FIG. 13, implemented as a web page created under HTML, is shown. The partner administration web page 1600 includes a center, upper horizontal portion having a partner selector field 1602 and a unit selector field 1604. The partner selector field 1602 is a drop-down menu that allows the name of the partner to be selected from a pre-selected group of partners. The unit selector field 1604 is a field that allows the partner to select how many navigation control units 125 to receive serial numbers for.

The partner administration web page 1600 also includes redirect URL fields 1606, editable fields 1608, and a submit button 1610. A left-hand, vertical column includes one or more redirect URL fields 1606. Each redirect URL field 1606 is preferably associated with a marking that indicates which user control 112 that the redirect URL field 1606 is associated with. A right-hand, vertical column includes one or more editable fields 1608. Each editable field 1608 is preferably associated with a redirect URL field 1606. A drop-down menu for the editable field 1608 is depicted where the partner can select between “yes” and “no,” but other types of input mechanisms are possible. A submit button 1610 is also depicted to allow a partner to submit all of the changes and entries on the partner administration web page 1600 simultaneously.

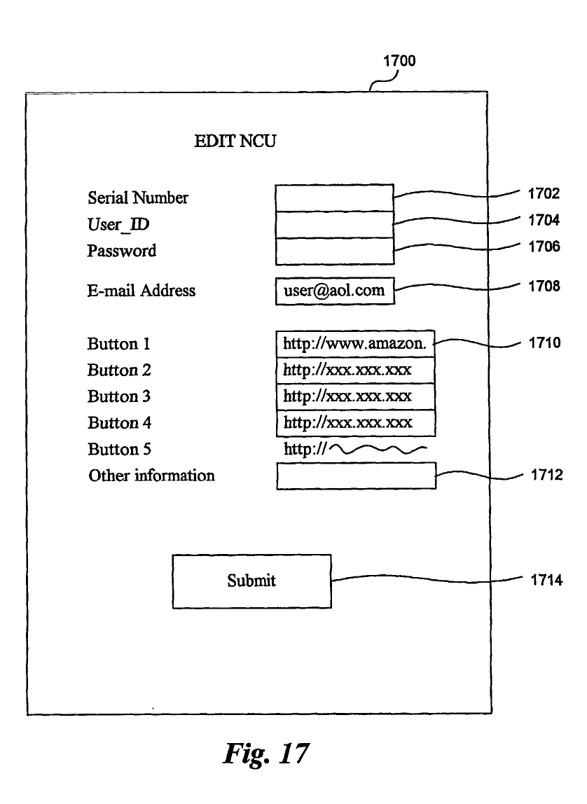

Referring to FIG. 17, a suitable display description of a user home web page, implemented as a web page created under HTML is shown. The edit navigation control unit (“NCU”) home page 1700 is depicted in FIG. 17, and is used by partners, administrators or users to edit the settings and configurations on an individual navigation control unit 120. In one preferred embodiment, the edit NCU home page 1700 is used by users on user computers 1002 to make changes to any user settings that the administrator and/or partner has allowed them to make.

In a center column, the edit NCU home page 1700 includes a serial number field 1702, a user_id field 1704, and a password field 1706. These fields are used to authenticate a user by requiring either a navigation control unit 120 serial number or user_id to be input by the user along with a confirmation password. Both a serial number and a user_id need not be entered. One slilled in the art will recognize that many alternative authentication techniques are available. In one alternative embodiment the serial number field allows for multiple entries or ranges of navigation control units 120, allowing global or mass changes of parameters. For example, if a partner changed its home page URL address, it could input that change simultaneously to all navigation control unit 125 serial numbers.

Also in the center column, the edit NCU home page 1700 includes an email address entry 1708 that is a field in which a user can make a change to the address used by the system to communicate with the user.

Also in the center column, the edit NCU home page 1700 includes one or more redirect URL fields 1710. The redirect URL fields allow the user to change some or all of the redirect URLs associated with various user controls 122. The new redirect URLs can be input manually or chosen for a drop-down menu, for example. Only user controls 122 that the partner or administrator has given the user edit permission accept entries from the user (buttons 1-4 in FIG. 17). Other user controls 122 that the user cannot modify are either shown as grayed-out (button 5 in FIG. 17) or are not shown at all.

Also in the center column, the edit NCU home page 1500 includes an other field 1712 and a submit button 1714. The other field 1712 can be used for comments, questions, or any other information that the user would be required to submit. A submit button 1714 is also depicted to allow a partner to submit all of the changes and entries on the edit NCU home page 1700 simultaneously.

In one embodiment of the navigation server 125, partners can provide redirect URLs in order to create revenue. For example, partners can receive funds from providing advertising on the web page that the user is linked with after actuating a user control 122 on a navigation control unit 120. The advertising can be deliver to the user before, during, or after the user can view the web page. By taking advantage of dynamic redirection, which allows modification of the redirection URL at any time, the redirection URL can be modified based on the user, the navigation control unit 120, other partners associated with the unit, demographic data about the user, data collected about the user's use of the navigation control device 120, the time of day, location of the user, etc. In this way, precise advertisements or web pages can be delivered to the user. As one example, a series of one or more advertisements could be delivered to the user either as content or before content is delivered. As one example, if the navigation control device 120 is connected with a location finding device such as a GPS receiver, the precise location of a user can be known. A restaurant chain such as McDonald's might provide a user control 122 on a navigation control device 120. When the “McDonald's” button was pushed, for example, the navigation control unit provides to the mobile device the current location, which is transmitted to the restaurant's site. (Alternatively, the mobile device may provide location determining data, such as by cell site triangulation, cell site sector and power level and other methods known in the art.) The restaurant's web site then determines the location of its closest restaurant and redirect the user to a web page containing that information. By delivering advertisements or content in this fashion, some objections to “push” technology can be overcome as the user must proactively request information.

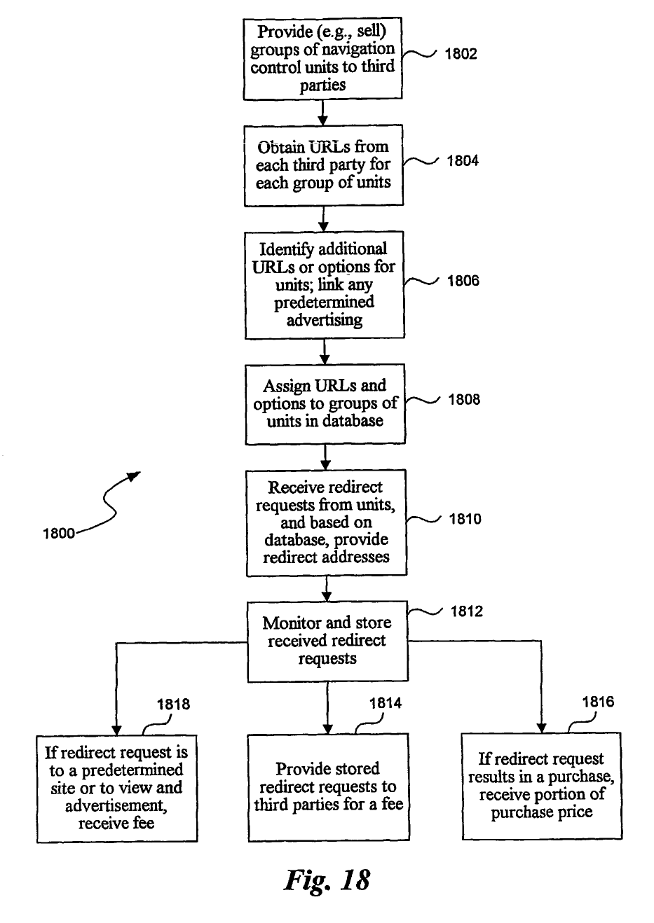

Referring to FIG. 18, a routine 1800 is shown for providing redirection capabilities to third parties, such as partners. In block 1802, an organization that hosts or provides the navigation server and associated services provides or sells groups of navigation control units to partners. In block 1804, the organization obtains URLs from each partner for groups of units. Each partner may provide one or more URLs that are associated with sites related to the partner, and that will be associated with hot keys on each navigation control unit. For example, if the partner is Version, the URLs will be associated with the following sites: the Virgin portal, Virgin Money, Virgin Guides, Virgin Music, and Virgin Travel. Likewise, if the partner is Amazon.com, the URLs will be associated with separate subpages at the Amazon.com site, such as Amazon.com/books, Amazon.com/music, Amazon.com/video, etc.

The navigation control unit may be provided free ourselves at a retail price directly to users to acquire and retain customers. Examples of URLs for UK customers include Football 365, Loot.com, E-Bookers, TD Waterhouse, Genie Portal. The navigation control unit may be provided to corporate partners to provide easy access to the company data, where the company provides the unit free to its employees. If, for example, the company was British Petroleum, examples of URLs include: BP latest sales figures, BP company directory, BP intranet, CNN financial news and Amex corporate travel. The navigation control unit may also be provided to retail partners to permit target customers for the retail partner to access Web sites related to the partner. The partner may sell such units to customers, or offer them for free. If the retail partner is directed to the use market, then example URLs include: HMV charts, Gameplay, Popcorn, email, Genie portal, etc.

In block 1806, the organization identifies any additional URLs or options for each group of units. For example, if a partner provides video games (e.g., Ludiwap Games), then the organization will help the partner identify related URLs based on demographics. For example, video games are often directed to a market segment containing males between ages of 12 and 20. Thus, the organization may provide additional URLs to related video games sites, such as sites for game playing cheats. Complementary sites they also be identified, such as food and clothing sites (Pepsi.com, Levis.com, etc.). Under block 1806, the organization may also identify any options for groups of navigation control units, such as which hot keys may be modified by users, and the like. Additional options may include pre-paid services, such as airtime on a mobile phone, or pre-paid time to play a WAP enabled game.

Furthermore, under block 1806, the organization may identify or negotiate with the partner on advertisements to be provided to users. Such advertisements may be provided as a home page for the users' wireless web access devices. For example, when a user powers up for cell phone, an initial start up screen may display an advertisements from the partner. The partner, a third party or the organization may generate the advertisements, which may be stored as an image file in the database, or stored at a third party server. Whenever the user powers up the phone, the phone accesses the navigation server and retrieves the stored advertisement. Of course, the advertisements may change frequently, e.g. daily. The advertisements may also include an offer to purchase a product or service, such as the book of the month.

In block 1808, the navigation server assigns and stores the URLs and options to groups of navigation control units in the database, as described herein. If pre-paid services are requested by the partner, the database also stores (and decrements or tracks) usage of such pre-paid services on a per unit basis. In block 1810, the navigation server receives redirect requests from navigation control units operated by users. Based on the database, the navigation server provides redirect addresses, as described herein.

In block 1812, the navigation server monitors and stores redirect requests received under block 1810. In block 1814, the navigation server provides stored redirect requests to third parties for a fee. Such stored requests may be compiled as reports. The navigation server may generate statistical and demographic reports.

In block 1816, if a redirect requests results in a purchase, then the organization receives a portion of the purchase price. The organization may receive a flat fee on a per product or periodic basis. Alternatively, the organization may receive a percentage from the purchase price of the purchase. Those skilled in the relevant art will recognize that various other compensation alternatives are possible.

In block 1818, the navigation server determines if the redirect requests under block 1810 is to a predetermined site or to view an advertisement. If so, then the navigation server may receive a fee from the advertiser, partner, or other third party. Thus, the organization receives revenue based on redirect traffic to predetermined sites or when users view or receive predetermined advertisements. The organization may receive revenue in various other ways. For example, a user, via the wireless device, may access enhanced software features available at the navigation server or elsewhere. The user may then download such enhanced software features for storage in the memory associated with the wireless device or navigation control unit. Such enhanced software features may include, for example, computer games, links to additional web resources, and other features described in this and other applications cited herein.

The organization effectively executes three phases. First, the organization provides low-cost navigation control units, that are operated by end-users. Second, the organization implements server software on the navigation server that allows for customer tracking and user and partner personalization. This personalization (choice of Web sites) may be specified down to individual users or groups of users. Modifications (web site choices) can be made with high or low frequency by the organization, partners or end-users. Third, the organization enters into partnerships with content providers and mobile Internet portals for providing content, advertising, and alike.

Under an alternative embodiment, the organization may provide licensed software that performs the functions described above. Thus, the organization may receive licensing revenue from the licensing of software that performs the redirect, monitoring and other functions described herein.

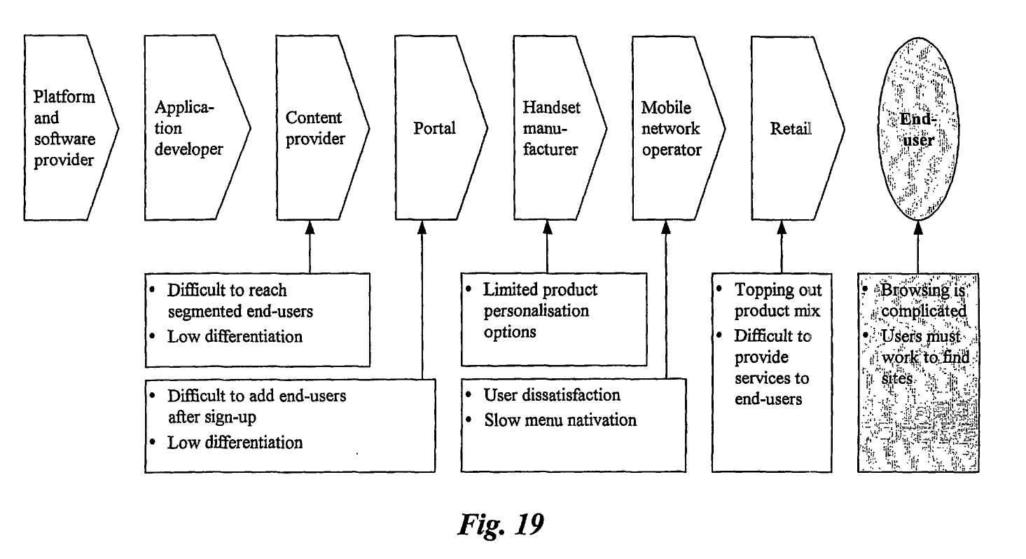

The inventors have recognized that mobile Internet devices are often “appliance-like”, rather than general computing devices. Thus, such devices are task driven, and not prone to general browsing and surfing. Instead, users employ only four or five preferred tasks or retrieve preferred content from certain sites. While computer applications are horizontal across groups of people (e.g., email, calendars, address books), mobile Internet content, commerce and services are segmented, so that four things that interest a young professional are different than those that interest a teenage music fan. Thus, successful marketing of mobile Internet content, commerce and services require bringing the sites to the user, not requiring users to find such sites. FIG. 19 shows problems identified by various third parties in a chain for providing mobile Internet content to users. As can be seen, these problems and more are solved by the invention. The navigation control unit allows partners to increase their customer base, simulate usage and increase their mobile electronic commerce (“M-commerce”). The navigation control unit allows users easy access to mobile Iternet/intranet content.

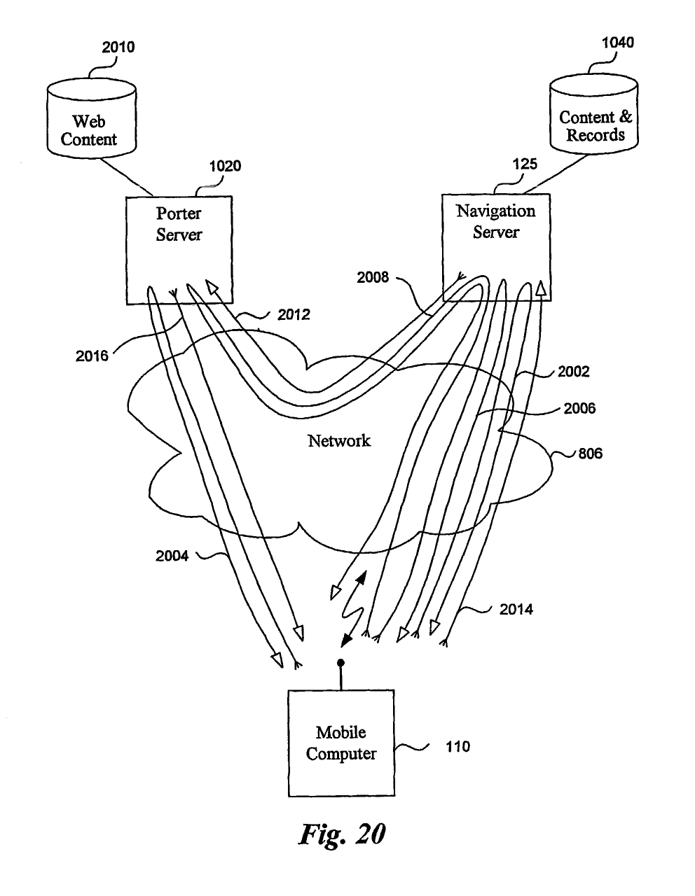

Referring to FIG. 20, four examples of delivering information to the wireless device 110 are shown. As generally described above, the navigation server provides a redirect URL that the wireless device uses to retrieve content from a third party computer, under a two-step process. As shown by a path 2002, the wireless device first requests and receives a redirect address based on user actuation of the user control (one of the hot buttons). In response, and as represented by a path 2004, the wireless device then employs in the redirect address to access the partner server computer 1020, which receives Web content from a database 2010, and returns it to the wireless device.

Under a first alternative, and as represented by a path 2006, the navigation server 125 stores locally the web content in the database 1040. Thus, rather than providing a redirect address to the wireless device, the navigation server simply returns the web content in response to the requests from the web access device.

Under a second alternative, and as represented by a path 2008, the navigation server itself retrieves the web content from the partner server computer 1020. Thus, the wireless device first requests web content based on user actuation of the user control. In response, the navigation server 125 accesses (based on a stored partner URL) and retrieves from the partner server computer 1020 the web content. The navigation server then provides the web content to the wireless device.

Under a third alternative, a first communication link is established between the wireless device 110 and the navigation server 125 (not explicitly shown, but similar to path 2002), the wireless device provides to the navigation server a request for Web content. In response, the navigation server obtains the URL, phone number, or other address of the wireless device (either from the device itself or from the database 1040), and provides this addresses with a command to the partner server computer 1020, requesting the partner computer to contact the wireless device directly (shown as a path 2012). The partner server computer then establishes a separate communication link with the wireless device to provide the originally requested content (not shown, but similar to 2004). Another alternative exists. Under a fourth alternative, the wireless device 110 requests access to a computer resource (such as requesting access to web content) based on a URL that is initially directed to the navigation server 125, as shown as a path 2014. The navigation server, acting in a manner like a Domain Name Server, effectively receives the URL and retrieves the appropriate personalization table in the database 1040 to identify the appropriate link to which the particular mobile device and actuated hot key are mapped. Based on the retrieved link the navigation server 125 effectively “resolves” the received URL into the link stored in the database. The navigation server then directs the request from the wireless device to another server, such as the partner server 1020, as represented by, for example, the path 2012. Based on the received request (possibly with additional information provided by the navigation server from data stored in the personalization table), the partner server provides predetermined web content to the wireless device, as shown by a path 2016.

As explained herein, the navigation control unit has several functions, and turns a mobile Internet device, e.g., a mobile phone, into a purpose-specific device. The navigation control unit automatically reconfigures the user's home page (and gateways or other settings, if desired). Furthermore, the navigation control unit simulates bookmarks (favorites) through use of the hot keys.

The system permits segmenting of audiences or groups of users either broadly into groups, or narrowly by individuals. Furthermore, the system permits businesses to provide content, commerce or services to those segmented audiences. Thus, the system permits the creation of narrowly defined vertical markets to which businesses may target their marketing efforts. The navigation control unit and navigation server (with database) permit each navigation control unit to be customized to individuals or segmented groups by defining and providing hot keys or automatic access to a small set of predefined web sites for that segmented group. For example, by simply plugging in a select navigation control unit into a web enabled mobile phone, the phone becomes effectively customized to a specific market segment (e.g., becoming a youth phone (with links to web sites for young adults), a sports enthusiast phone (with links to sporting web sites), an entertainer phone (with links to restaurant and theater web sites), a business traveler phone (with links to web sites for reservations, weather, etc.)).

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole, and not to any particular portions of this application.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. For example, the navigation control unit may be integrally formed with the wireless device, and not be a separate device to be connected with the wireless device. The teachings of the invention provided herein can be applied to other systems, not necessarily for the wireless web access system described above. The elements and acts of the various embodiments described above can be combined to provide further embodiments.

All of the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all systems that operate under the claims to provide a method for providing access to computing resources. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

### Appendix A

### Configurations

Suitable configurations for one embodiment are as follows. Of course other systems and configurations are possible.

The development environment includes

RedHat Distribution 6.2

Linux Kernel Version 2.2.14-5

Unfortunately, the development environment may already be in use so when you install RedHat so you may need to go back and install packages from the CD. You will usually be prompted when using rpm (RedHat Package Manager) when a needed package is not installed. You can usually locate these packages on the CD or you might want to try downloading them from htt://rpmfind.net.

You will also want to run Bastille on both servers in order to shut down all services that you do not need. Bastille is an interactive Perl program so read the README file and follow the instructions when prompted. Be careful not to shutdown port 80 on the webserver or the port that MySQL listens to (3306 is the default but you may want to check this using “netstat -an |grep mysql”). Bastille will create a mini-firewall for you to install, which is a good idea. After you have both Apache and MySQL installed, you should test the Apache and MySQL ports by telneting to them and seeing if they are listening and responding. You may also want to refer to the following articles on shutting down unnecessary services on Linux:

System Security:

htt://www.rootprompt.org/article.php3?article=922

Is my System Secure?

http://www.rootprompt.org/article.php3?article=723

While neither article is a comprehensive list of steps to take they do illustrate the kdnds of things that will be important in protecting the system.

Telnet should be locked down and SSH installed instead. SSH can be obtained from http://rpmfind.net/linux/rpm2htm1/search.php?guery=ssh or at http://www.openssh.org.

Lastly, make sure you install all updates and patches for any software you have running on the system. You can check for RedHat supplied software at: http://www.redhat.com/support/errata/. You should also check the BugTraq mailing list archives http://www.securityfocus.com/ and CERT http://www.cert.org/.

The following are instructions for setting up and configuring Apache, mod_perl, and the software. If Apache was already installed as part of the OS setup, remove it. You can check if Apache is installed by typing:

rpm -q apache

If it is installed, remove it by typing rpm -e apache (you may have to type in the complete package name). If there are dependencies, remove them as well.

The applications are listed in the order that they must be installed. Instructions assume that Perl 5.005 or greater has already been installed during OS installation. Apache can be found at htt://www.apache.org. mod_perl can be found at http://perl.apache.org. All other modules can be found at http://www.cpan.org.

First, copy all of the below files to /usr/local/src. Untar the files with tar -zxvf NAME OF FILE.

Apache 1.3.17

Apache can be installed with the default configuration. Simply type ./configure, make, make test and make install. Apache will install itself in /usr/local/apache. Once Apache is installed do a “ls -la” on the /usr/local/apache/bin directory and note the file size of the httpd binary. You will need to compare the size later so you may want to write it down.

CGI.pm 2.752

Digest DM5 2.12

HTML Tagset 3.03

HTML Parser 3.17

MIME Base64 2.12

URI 1.10

Libnet 1.0703

Libwww_perl 5.50

mod_perl

To build the mod_perl make file, use the following command line arguments:

pern Makefile.PL EVERYTHING=1

APACHE_PREFIX=/usr/local/apache

Answer “Y” (Yes) to “Configure mod_perl with ../apache_{—}1.3.17/src?” and “Shall I build httpd in ../apache_{—}1.3.17/src for you?”

Next do a make, make test and make install. mod_perl may or may not install the new httpd binary into the /usr/local/apache/bin directory. Check the file size against the file size you noted during the Apache installation to see if they are different. If not, look in the Apache source directory (/usr/local/src/apache_{—}1.3.17/src) and there should be a new httpd binary (check file size to make sure). Copy the old httpd binary to httpd.bak (cp /usr/local/apache/bin/httpd /usr/local/bin/apache/httpd.bak) and then copy the new binary to /usr/local/apache/bin/httpd (cp /use/local/src/apache_{—}1.3.17/src/httpd /usr/local/apache/bin/httpd).

Now you will need to configure the Apache server and test the mod_perl configuration. Open the file located at /usr/local/apache/conf/httpd.conf and set the ServerName, ServerAdmin and IP address settings as appropriate for the machine. Go to the end of the file and add the following:

############# SeCo specific #####################

PerlRequire conf/startup.pl

PerlFreshRestart On

<Location /hello/world>

SetHandler perl-script

PerlHandler Apache::Hello

<Location>

<Location /marie>

SetHandler perl-script

PerlHandler Apache::MARIE

</Location>

Copy startup.pl to the /usr/local/apache/conf/directory.

Next, create the following directories:

mkdir /usr/local/apache/lib

mkdir /usr/local/apache/ib/perl

mkdir /usr/local/apache/lib/perl/Apache (Capital “A”)

Copy Hello.pm and MARIE.pm to the /usr/local/apache/lib/perl/Apache directory.

Execute the following command to restart the server:

/usr/local/apache/bin/apachectl restart

Check for any errors and correct.

Open a web browser and attempt to connect to the webserver. If you can connect to the webserver, connect to http://www.nameofwebserver.com/hello/world/. If you do not get an error message everything should be configured properly.

If everything is working correctly you will want to add Apache to your initialization scripts so it starts every time the server is booted. The apachet file is essentially a startup script. Change directories to /etc/rc.d/init.d/ and then create a symbolic link to the apachectl file (ln -s /usr/local/apache/bin/apachectl httpd). Edit the httpd file (which will also edit the apachectl file) and add the following near the beginning of the script (the best place is probably immediately following the first line “#!/bin/sh”):

# Added by Bill Rini 02.25.01 in order to use chkconfig

# chkconfig: 345 01 99

# description: Apache is a http webserver

Make sure the lines are prefixed with a “#” symbol to signi comments.

Next, type the following command:

chkconfig --add httpd

Next you will need to install the MySQL database and the associated modules that allow Perl to access it (DBI/DBD drivers). This will be on a different server than where you installed Apache.

Istall in the following order:

MySQL 3.23.33-1

MySQL Client 3.23.33.1

DBI 1.14

MySQL Shared 3.23.33-1

MySQL Devel 3.23.33-1

Data Dumper 2.101

Data Showtable 3.3

Zlib Devel 1.1.3-6

MSQL—MySQL Modules 1.2215

You will want to change the system password on the database next. There are four pre-installed passwords. For the development environment, I chose to change them all by changing all passwords and then changing the root passwords. The commands are as follows:

mysql -u root mysql

mysql>UPDATE user SET Password=PASSWORD(‘mysql’);

mysql>FLUSH PRIVILEGES;

mysql>UPDATE user SET Password=PASSWORD(‘seco’) WHERE user=‘root’;

mysql>FLUSH PRIVILEGES;

All non-root passwords are now set to mysql and the root password is set to seco. Of course, in production you will want to use a somewhat more secure password selection.

M.A.R.I.E

M.A.R.I.E (a.k.a. Mobile Address Redirect Identification Embodiment) is an Apache module that accepts the incoming request from the mobile phone WAP browser, looks up the associated information in a database and then redirects the browser to the corresponding location.

MARIE is implemented as an Apache handler. Handlers allow you to step into the Apache normal process flow and perform actions, including stopping the process. For instance, a very simplified HTTP exchange might be as follows: Apache receives a request; Apache retrieves the requested document; Apache returns the requested document. An Apache handler would allow one to step into any point in the process and perform some operation. In the case of MARIE we want to step in as soon as the request is received, parse the request string, query the database, and send the browser to a new location.

Acting as a handler, MARIE has distinct advantages over a CGI program in that one can eliminate the entire overhead of making a request to the file system, and starting up the Perl interpreter. While on the surface these resource saving may seem trivial they improve performance significantly.

Assuming requests take the form of htt://www.ptwg.net/marie/aaaaaa/bbbbb (aaaaaa=serial number and bbbbb=button pressed) the general logic is as follows:

Get the requested URI (i.e. /marie/aaaaaa/bbbbb)

Parse out the relevant values aaaaaa and bbbbb

Check that the values are in a valid format

Using DBI/DBD query the database (i.e. select bbbbb from USER_PROPS where USER_ID=aaaaaa)

Log the redirect location

Return to WAP browser a 302 Redirect message such as (Most browsers will not even display the HTML but will go directly to the redirect site.

The HTML is included in order to be 100% standards compliant):

GET /marie/aaaaaa/bbbbb HTTP/1.0

HTTP/1.1 302 Found

Date: Sat, 24 Feb 2001 19:03:51 GMT

Server: Apache/1.3.17 (Unix) mod_perl/1.25

Location: http://www.yahoo.com

Connection: close

Content-Type: text/html; charset=iso-8859-1

<!DOCTYPE HTML PUBLIC “-//IETF//DTD HTML 2.0//EN”>

<HTML><HEAD>

<TITLE>302 Found</TITLE>

<HEAD><BODY>

<H1>Found</H1>

The document has moved <A

HREF=“http://www.yahoo.com”>here</A>.<P>

<HR>

<ADDRESS>Apache/1.3.17 Server at localhost Port 80</ADDRESS>

<BODY></HTML>

Connection closed by foreign host.

Further information regarding implementing aspects of the invention may be found in the above detailed description.

We claim:

1. A method for controlling navigation within the Internet by a user on a wireless web access device, the method comprising:
receiving a user request from the wireless web access device, wherein the user request includes information identifying a navigation control unit coupled to the wireless web access device and information about a selected user control on the navigation control unit actuated by the user;
parsing the user request to extract information identifying the navigation control unit and information about the selected user control actuated by the user from the user request;
retrieving a personalization table from a personalization database based on the information identifying the navigation control unit;
obtaining a redirection address based on the retrieved personalization table and the selected user control actuated by the user, wherein the redirection address is associated with a web page accessible from the Internet, wherein the web page is associated with a third party partner;
generating a redirect command based on the redirection address; and
providing the redirect command to the wireless web access device to permit the wireless web access device to automatically access the web page based on user actuation of the selected user control.

2. The method of claim 1, further comprising:
verifying the received user request;
storing information regarding the received request for subsequent report generation;
receiving from the third party partner a request to alter the redirection address for the selected user control in the personalization table;
storing in the personalization database the altered redirection address for the selected user control in the personalization table;
receiving from the user a request to alter in the personalization table another redirection address associated user actuation of another user control on the navigation control unit; and
storing in the personalization database the altered another redirection address for the another user control in the personalization table.

3. The method of claim 1, further comprising:
obtaining a set of identification numbers associated with a group of navigation control units;
associating in the personalization database the redirection address for the selected user control for each navigation control unit in the group of navigation control units;
providing an advertisement for display by each wireless web access device associated with each navigation control unit in the group of navigation control units; and
receiving from the third party partner compensation based on the advertisement or based on requests received from the group of navigation control units to access the web page associated with the redirection address.

4. A method for controlling navigation within the Internet by a user on a wireless web access device, the method comprising:
receiving a user request from the wireless web access device, wherein the user request includes information identifig a navigation control unit coupled to the wireless web access device and information about the user control actuated by the user;
parsing the user request to extract from the user request information identifying the navigation control unit and information about the user control actuated by the user;
querying a personalization database to determine a redirection address, wherein the redirection address is associated with a web page accessible from the Internet;
receiving the redirection address from the personalization database;
generating a redirect command based on the redirection address; and
transmitting the redirect command to the wireless web access device.

5. The method of claim 4, further comprising verifying that the extracted information to confirm that the information is properly formatted.

6. The method of claim 4, further comprising saving usage information in a database, wherein the usage information includes information about the user and the user control actuated.

7. The method of claim 4 wherein the information identifying the navigation control unit is a serial number.

8. The method of claim 4, further comprising:
providing a display description to permit altering of the redirection address in the personalization database.

9. The method of claim 4 wherein the information identifying the navigation control unit is a partner associated with the navigation control unit.

10. The method of claim 4 wherein the redirection address is a URL.

11. The method of claim 4 wherein the query to the personalization database is based on parameters determined by a partner.

12. The method of claim 4 wherein the query to the personalization database is based on the location of the navigation control unit.

13. The method of claim 4 wherein the query to the personalization database is based on the usage information related to the user of the navigation control unit.

14. An apparatus for configuring addresses stored in a database, the apparatus comprising:
means for receiving information identifying navigation control units to be modified, wherein each of a plurality of navigation control are units coupled with associated wireless web access devices;
means for receiving information regarding configuration of user controls, wherein at least one of the user controls is associated with an updated redirection address; and
means for modifying a personalization database for each identified navigation control unit by changing a redirection address associated with the at least one of the user controls to the updated redirection address.

15. The apparatus of claim 14 wherein the information identifying the navigation control units to be modified is the name of a partner.

16. The apparatus of claim 14 wherein the means for modifying a personalization database includes identifying at least one user control for configurability by users.

17. A computer-readable medium whose contents cause a server computer to provide network addresses regarding location of a computer resource coupled to a network, comprising:
receiving a user request from a portable wireless computer resource access device, wherein the user request includes information identifying a navigation control unit coupled to the wireless access device and information about one of two or more the user controls actuated by the user;
obtaining a redirection address from a database based on the information identifying the navigation control unit and the one user control actuated by the user, wherein the redirection address is associated with a computer resource accessible from the network; and
providing the redirection address to the wireless access device to permit the wireless access device to automatically access the computer resource via the network.

18. The computer-readable medium of claim 17 wherein the computer resource is a web site and wherein the redirection address is URL.

19. The computer-readable medium of claim 17 wherein the computer-readable medium is a logical node in a computer network receiving the contents.

20. The computer-readable medium of claim 17 wherein the computer-readable medium is a computer-readable disk.

21. The computer-readable medium of claim 17 wherein the computer-readable medium is a data transmission medium transmitting a generated data signal containing the contents.

22. The computer-readable medium of claim 17 wherein the computer-readable medium is a memory of a computer system.

23. A method, comprising:
providing a computing system configured for:
querying a personalization database containing information about redirection addresses associated with individual navigation control units; and
receiving revenue under at least one of the following acts (a) through (e):
(a) receiving advertising revenue for providing advertising on web pages that users of the navigation control units are redirected to;
(b) receiving revenue for selling usage information collected from users of navigation control units;
(c) receiving revenue for licensing the system to a third party;
(d) receiving fees from retailers based on products purchased by users of navigation control devices from web pages associated with retailers; and
(e) receiving revenue for directing network traffic to a particular redirection address.

24. A computer-readable medium containing a data structure for use by a navigation server, the data structure comprising:
a plurality of user records for storage in a personalization database, wherein each record comprises:
an identification value corresponding to one of a group of navigation control units, wherein the navigation control unit is associated with a wireless computer resource access device;
two or more URLs associated with redirection addresses for accessing web pages on the Internet;
data field indications of two or more the user operable controls associated with the navigation control unit, wherein each data field indication is associated with one of the two or more URLs; and
fields associated with each of the two or more URLs that indicate whether a user may alter the URL.

25. The computer-readable medium of claim 24 wherein the identification value is a serial number of the corresponding navigation control unit, wherein the navigation control unit is a device connectable with the wireless computer resource access device, and wherein each record further comprises a partner identification that corresponds to a third party partner and at least one of the URLs.

26. The computer-readable medium of claim 24 wherein the identification value is an identification of a third party partner associated with one of the URLs, and wherein the navigation control unit is incorporated within the wireless computer resource access device, and wherein the record stores a credit card number for a user associated with the wireless computer resource access device.

27. An apparatus coupled to a wireless web content access computer via a wireless network, the apparatus comprising:
a database, wherein the database stores at least one record storing information corresponding to a navigation control component associated with the wireless web content access computer;
a server computer coupled to the database and to the wireless network, wherein the server computer is configured to:
receive a user request from the wireless web content access computer, wherein the user request includes information corresponding to the navigation control component associated with the wireless web content access computer and information about one of two or more the user controls actuated by the user;
query the database based on the information identifying the navigation control unit associated with the wireless web content access computer and the one user control actuated by the user; and
provide web content to the wireless web content access computer to permit the wireless web content access computer to automatically display the web content.

28. The apparatus of claim 27 wherein the server computer is further configured to:
retrieve a redirection address from the database record based on the database query;
access a third party server computer based on the retrieved redirection address; and
obtain the web content from the third party server computer.

29. The apparatus of claim 27 wherein database stores the web content for retrieval by the server computer.

30. The apparatus of claim 27 wherein the navigation control component is incorporated within the wireless web content access computer, and wherein the server computer is further configured to receive a request to alter data stored in the database from a third party partner computer, and to alter the database based on the received request.

31. A computer-readable medium containing a data structure having information for displaying information regarding personalization record associated with a wireless computer resource access device representing a client under a client-server system, wherein the client-server system includes a network coupling the wireless computer resource access device with a server computer, the information comprising:
a display description defining:
at least first and second user control display portions corresponding to user operable controls associated with a group of navigation control components, wherein the group of navigation control components are associated with a corresponding group of wireless computer resource access devices;
at least first and second URL fields for redirection addresses for accessing web pages on the Internet, wherein the first and second URL fields are associated with the first and second user control display portions; and
fields associated with each of the first and second URL fields that indicate whether a user may alter the URL.

32. The computer-readable medium of claim 31 wherein the data structure represents a Web page.

33. The computer-readable medium of claim 31 wherein the data structure represents a document for display.

34. The computer-readable medium of claim 31 wherein the data structure is a data transmission medium transmitting a generated data signal containing the data structure.

35. A method at least partially implemented by a computer for permitting wireless web content access devices to automatically access web content, comprising:
obtaining a group of identifications associated with a group of the wireless web content access devices or a group of navigation control components associated with the group of wireless web content access devices, and wherein a predefined market segment is associated with users of the group of the wireless web content access devices;
associating at least two different links for each identification in the group of identifications, wherein the two different links are associated with the predefined market segment;
receiving a request for web content from one of the wireless web content access devices in the group of wireless web content access devices, and an identification associated with the one wireless web content access device; and
based on the identification associated with the one wireless web content access device, providing the wireless web content access device with access to predetermined web content.

36. The method of claim 35, further comprising:
logging the received request;
providing a report reflecting the logged received request to a third party partner; and
receiving payment from the third party partner.

37. The method of claim 35, further comprising:
providing enhanced user features to at least one requesting user; and
receiving payment from the requesting user.

38. The method of claim 35, further comprising:
licensing software routines to at least one a third party partner, wherein the software routines perform the acts of obtaining, associating receiving and providing.

39. The method of claim 35, further comprising:
providing the group of navigation control components for coupling with the group of wireless web content access devices, wherein the group of identifications are associated with the group of navigation control components; and
wherein the two different links are redirect URLs, and wherein providing the access to predetermined web content includes providing one of the redirect URLs to the one wireless web content access device to permit the one wireless web content access device to access web content provided by a third party partner, and wherein the Web content is associated with the predefined market segment for the third party partner.

40. The method of claim 35, further comprising:
receiving from a third party partner a fee based on providing the access to predetermined web content, based on providing an advertisement to a user, or based on purchase of a good or service associated with the third party partner by the user via the wireless web content access device.

41. The method of claim 35 wherein the two different links are redirect URLs, and wherein providing the access to predetermined web content includes retrieving the predetermined web content from a server computer associated with a third party partner, and providing the predetermined web content to the one wireless web content access device, and wherein the web content is associated with the predefined market segment for the third party partner.

42. The method of claim 35 wherein at least one of the two different links is a mobile address of the one wireless web content access device, and wherein providing the access to predetermined web content includes providing the mobile address a server computer associated with a third party partner, and wherein the server computer establishes communication with the one wireless web content access device and provides the predetermined web content to the one wireless web content access device, and wherein the web content is associated with the predefined market segment for the third party partner.

43. The method of claim 35 wherein the two different links are links to web content locally stored, and wherein providing the access to predetermined web content includes retrieving and providing the predetermined web content to the one wireless web content access device, and wherein the web content is associated with the predefined market segment for a third party partner.
